(19) United States
(12) Patent Application Publication
(10) Pub. No.: US 2010/0308174 A1
(43) Pub. Date: Dec. 9, 2010

(54) ROTOCRAFT POWER-GENERATION, CONTROL APPARATUS AND METHOD

(76) Inventor: Grant Calverley, Friday Harbor, WA (US)

Correspondence Address: ROBERT PLOTKIN, PC, 15 New England Executive Office Park, Burlington, MA, 01803, US

(21) Appl. No.: 12/792,203

(22) Filed: Jun. 2, 2010

Related U.S. Application Data
(60) Provisional application No. 61/183,901, filed on Jun. 3, 2009.
(60) Provisional application No. 61/253,925, filed on Oct. 22, 2009.

(51) Int. Cl. B64C 31/06

(52) U.S. Cl. 244/155 A

(57) ABSTRACT

A control system for a power generation apparatus and method may fly a rotorcraft rotary wing at an altitude above the nap of the earth. A tether, suitably strong and flexible, connected to the rotorcraft framing is pulled with a force generated by the rotary wing. The force is transmitted to a ground station that converts the comparatively linear motion of the tether being pulled upward with a lifting force. The linear motion may be transferred to a rotary motion in the ground station to rotate and electrical generator. The tether may be retrieved and re-coiled by controlling the rotorcraft aircraft to basically fly down at a speed and lift force to support recovery of the rotorcraft at a substantially reduced force compared to the larger lifting force in effect during the power-developing payout of the tether. Moreover, the duty cycle of such a system is substantially increased over any terrestrially based or tower-mounted wind turbine mechanisms.

### RELATED APPLICATIONS

This application claims the benefit of co-pending U.S. Provisional Patent Application Ser. No. 61/183,901, filed on Jun. 3, 2009 for a TETHERED ROTARY FOIL POWER GENERATION, and co-pending U.S. Provisional Patent Application Ser. No. 61/253,925 filed on Oct. 22, 2009 for AUTOGYRO POWER GENERATION APPARATUS AND METHOD, both of which provisional patent applications are hereby incorporated by reference in their entireties

### BACKGROUND

1. The Field of the Invention

This invention relates to control of aircraft, and, more particularly to control of tethered rotorcraft as a mechanism to generate power.

2. The Background Art

Autogyro aircraft are a form of powered or unpowered rotorcraft, typically having one or more auto-rotating airfoils or blades. Helicopters have one or more powered, rotating airfoils or blades. Gyrodynes power the rotor in preparation for takeoff, then fly with a freewheeling rotor (rotary wing) in flight pushed by a pusher propeller. Helicopters power the rotary wing with an onboard engine. Various versions of these have been developing since the first quarter of the Twentieth century. During the 1930's autogyro aircraft were actually employed commercially as rotary wing aircraft shuttling mail.

Wind energy has been developed along a path substantially independent from aircraft for many years. The development of the American frontier was largely facilitated by the windmill. Large windmills were placed on towers. The windmill, capturing the local wind energy operated just as windmills had operated for centuries in Holland and elsewhere in the world. Gristmills relied on waterpower, but sometimes relied on wind power. The pumps that continue to drain the water from the lowlands of Holland have been driven by wind for centuries through the sail-like blades of windmills. Receiving momentum from the passing wind, and redirecting the wind, they harvest that momentum into motion of the windmill.

By appropriate mechanical linkages, a windmill may pass energy as a linear translation or as a rotary motion to some other operational mechanism. For example, a gristmill transfers the energy of the wind, vanes or blades of the mill to the rotatory motion of a grinding stone Likewise, a pump will typically operate in a reciprocating linear motion alternately drawing and returning a piston lifting water.

In the early twentieth century, generators, operating largely as windmills were installed at remote locations inaccessible by public utilities. Such system relied on a windmill-like blade or multiple blades turning a generator, storing energy in batteries.

In more recent years, towers have been erected in various configurations supporting blades that reflect all the aerodynamic engineering of aircraft wings and aircraft propellers acting to retrieve energy from the wind, rather than drawing an aircraft or pushing an aircraft through the air. Thus, large systems have been developed at substantial cost to elevate wind turbine blades, propellers, or the like above the surface of the earth in areas of high wind, constant wind, or otherwise commercially feasible locations of wind energy available for harvest.

Nevertheless, wind energy has been difficult and expensive to develop. Wind on the surface of the earth is predictable primarily as weather patterns, or as a daily, directional breezes. Wind energy is at best unpredictable.

Nevertheless, the physical structures available, and the methods of installing them, are limited by the physics and engineering available to exploit them. It would be an advance in the art to develop a method and apparatus to capture wind energy using a greater duty cycle than is typically available for terrestrial windmill locations.

### BRIEF SUMMARY OF THE INVENTION

In view of the foregoing, in accordance with the invention as embodied and broadly described herein, a method and apparatus are disclosed in one embodiment of the present invention as including an autogyro rotary wing secured to a frame, fuselage, nacelle, or the like to be controlled as to the blade angle of attack with respect to relative wind passing over the blade or wing. A rotor of an autogyro may as well control the rotor disk pitch or angle of attack with respect to incoming wind. The blade angle of attack and the rotor disk pitch angle or angle of attack may be either independent from or dependent on one another. Meanwhile, the frame may be tethered to a ground station.

In certain embodiments, the rotorcraft may be connected directly to a generator or generating mechanism that flies with the rotorcraft blade at flight altitude. Nevertheless, in other embodiments contemplated, the force of lift pulling a tether may generate power. The blades or the rotor blades of the rotorcraft may fly upward through the air having a bare minimum of frame, fuselage, or the like. Thus, the rotorcraft may be so light that its stall speed is easily met even in the slightest wind. In this embodiment, the tether itself may be connected to a mechanical linkage capable of converting the lift energy transferred through the tether to the ground station.

For example, in one embodiment, an autogyro may be “flown” upward through the air on a tether. As the rotorcraft flies upward, the flight controls for the rotary wing may be set to obtain maximum lift. Accordingly, a rotor of an autogyro may produce substantial lift, from a few pounds, in the case of a rotor a few feet in diameter, to a ton, for a large rotor dozens of feet in diameter.

A rotor capable of lifting another 2000 pound aircraft is capable of lifting a 2000 pound load. That is, a rotor blade capable of suspending a one ton weight in the air, can instead apply one ton of force to a tether, lifting that tether against a reel. As the reel pays out the tethering line (e.g., cable, rope, wire rope, or the like), a linkage to the reel may provide rotary motion to a generator.

The recovery portion of an energy cycle may be accommodated by reeling in the tether, while flying the rotorcraft at an attitude and lift that barely, or otherwise appropriately, exceeds the force needed to lift the tether or support it in the air. Thus, for example, in one embodiment, an autogyro may exert, for example, 1500 pounds of force over and above the weight of the tether. Thus, in addition to lifting the tether, the rotorcraft may provide 1500 pounds of force through a distance of flight of several hundred or more than 1000 feet of climb through the air.

Meanwhile, at the end of such a “power stroke” the rotorcraft may be flown downward at a rate, and with a lift force that is just sufficient to maintain proper tension and support the weight of the tether. The difference of the comparatively higher force through the distance during lift, compared to the comparatively lower force through the distance of retreat downward by the rotorcraft is an energy difference that may be captured by a generator at the ground station.

Thus, by controlling the blade angle of attack, that is, the angle that the chord of the airfoil of the rotary blade makes with respect to the incoming air passing over it or past it otherwise, an autogyro rotary wing may be flown to control lift force, as well as direction. The rotorcraft may be flown upward and downward, quite literally.

Meanwhile, the blade angle of attack is distinguishable from the rotary wing angle of attack. Thus, the wing angle of attack or the rotor disk path angle with respect to the wind, may also be controlled in order to control drag, lift, and the like. In certain embodiments, such as when using a delta type of connection, the blade angle of attack and the relative rotational speed of the blade may actually be coupled. Coupling may provide more drag and lift as the rotational speed of a blade reduces, and decrease drag and lift as the relative speed increases, in order to stabilize the system. It may help to reduce drag particularly when the wind speed is comparatively higher. It may increase the lift, at the expense of increased drag, whenever the rotary blades are rotating at a comparatively slower speed, typically due to decreased local wind velocity or startup condition.

The wind velocity with respect to he earth is much more stable above the nap of the earth. At the level of building, hills, trees, and the like, wind velocities are decreased substantially by obstructions. Even in the presence of mountains, wind velocities are altered, and directions are substantially altered due to obstruction. However, it is possible to fly an autogyro on a tether at an altitude above the tops of the mountains. At a minimum, autogyro aircraft can be flown sufficiently above the nap of the local terrain features to obtain substantially constant wind.

This does not mean the wind direction and velocity never change. By this is meant that there is substantially always wind, whatever its direction. However direction is not as radically altered at flight altitudes by having a tethered system having a central pulley or head through which a tether, such as a fiber or wire rope passes, the rotorcraft aircraft may fly in the local wind, at whatever direction the wind is present. Likewise, the rotorcraft aircraft may be flown according to the conditions of the wind, in order to maintain lift, first of all, and then energy production thereafter. The system may be regulated by autopilot functionality controlling the blade angle of attack, rotor disk angle of attack, or both, independently or dependently. Thus, for example, autogyro aircraft may be flown in substantially never-ending wind at an altitude of 5000 feet to over 30,000 feet above the Earth.

As a practical matter, airspace control may be affected by wind farms or sky mills in accordance with the invention. Therefore civil authority over airspace must be considered.

In general, the principles of autogyro aircraft operation and control are discussed in U.S. Pat. No. 5,301,900 issued Apr. 12, 1994 to Groen et al, which patent is incorporated herein by reference in its entirety. That reference discusses in detail the value of an adjustable angle of attack of a rotary blade, as well as the dissymmetry of life, that occurs in the advancing and retreating portions of the path of a rotating blade.

Thus, although the discussion here uses the expression “rotor disk” and the “rotor disk” angle of attack or the like, rotor blades tend to distort into something of a conical shape, as a result of loading. Also the rotor disk or rotor cone tends to fly with the axis of rotation canted toward the retreating side at an angle, a roll angle, with respect to the actual axis or rotation.

For example, the advancing blade has an increased relative air speed with respect to the incoming wind. By contrast, the retreating blade has a comparatively lower relative velocity because it is flying in same direction that the wind is blowing. Thus, the relative wind velocity is reduced. Accordingly, the advancing blade flies higher, while the retreating blade flies lower. This results in the rotor disk or rotor cone canting off or rolling off to the retreating side. This is no problem for flying the aircraft. It is simply the consequence of flight, and is accommodated by proper design of the mounting hardware for the rotor hub supporting the rotor blades.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic representation of a system including one or more rotorcraft flying against the tension of a tether connected to a take-up device generating power in reliance on the cyclical pulling on the tether a distance at a tension force and retreating back down against a lower force by flying the rotorcraft in a reduced lift orientation;

FIG. 2 is a schematic end view of a blade of a rotor in accordance with the system of FIG. 1 illustrating the net resultant of the forces of lift, gravity, drag, and so forth with respect to the rotating blade of a rotor of an autogyro;

FIG. 3 is a schematic diagram of the attitude of a rotor of an autogyro with respect to the incoming wind passing through the under side of the rotor;

FIG. 4 is a schematic diagram of a system in accordance with FIG. 1 including multiple rotorcraft attached to a single tether and together adding the net tension in the line as seen by the take-up device and power generation system connected thereto;

FIGS. 5A-5C are side elevation views of a specific embodiment of an autogyro in accordance with the invention in various attitudes of flight ranging from stabilized, almost level flight to an aggressive attitude to an initiation or autogyro position for launching.

FIG. 6 is a perspective of one embodiment of an apparatus using a minimum fuselage, an open frame, for an autogyro tethered to a system of FIG. 1, and incorporating both roll and pitch control between the tether and the frame of the rotorcraft aircraft;

FIG. 7 is a perspective view of an alternative embodiment of an autogyro for use in a system in accordance with the invention, including spur gears operating on tracks, the tracks disposed along the frame of the rotorcraft aircraft in order to control pitch and roll orientations of the aircraft frame. While this embodiment also includes a “resting” location in the tracks devoted to aircraft pitch control, the tracks changing radius in order to provide a preferential pull location to which the aircraft frame may tend, due to the lower location thereof in the track;

FIG. 8 is a perspective view of an alternative embodiment of a rotor, and includes a frame reduced to a minimum mechanical structure secured to a tether, and providing for pitch control by an actuator acting between the minimalist frame and a boom connected to an inner, substantially stationary, of a bearing system of a hub of the rotorcraft;

FIG. 9 is a perspective view of an alternative embodiment of the apparatus of FIG. 8, including a pass-through of the tethered line to secure another autogyro at higher altitude on the same tether;

FIG. 10 is a perspective view of an alternative embodiment of an autogyro, similar to the apparatus in FIG. 6 having a tiltable deck that may pitch with respect to the main frame, in order to provide additional control of the rotor angle of attack or rotor pitch with respect to the incoming air stream;

FIG. 11 is a top plan view of one embodiment of a rotor using pivots canted away from perpendicular to a radius of the hub, in order to provide a coupling of the flapping or hinged action of the individual blades, with the change of the blade angle of attack;

FIG. 12 is a top plan view of an alternative embodiment of the apparatus in FIG. 11, showing optional power generation schemes, including magnets and coils, as well as an optional jet, where the coils and jet need not be used in combination, but rather the coil system may provide auxiliary electricity for operating supporting equipment such as controls or autopilot on board the rotorcraft, while a jet may be used for controlling flight during startup, flydown, or the like;

FIG. 13 is a top plan view of an alternative embodiment of a rotor, including the central hub, the pivot points between the tubes or anchors on the hub and the rotor blades, in this case having hinge axes perpendicular to a radius from the center of the hub, but the blades themselves canted at an angle forward in the leading edge direction instead of on the radii emanating from the hub;

FIG. 14 is a perspective, partially cut away view of an alternative embodiment of a rotor, with the blades truncated in order to expand the viewing size of the hub, the hub including anchors acting as devises holding trunnions for connecting the respective blades, and the blades pivoting about pivot pins passing through the anchors;

FIG. 15A-15B are side elevations views of an alternative embodiment of an autogyro in accordance with the invention, having a tethered frame supporting a rotor, and including biasing elements such as springs, mechanical actuators, servos, or the like, in order to bias each blade to an upward position, the upward position thus coupling, due to a canting of the blade or the pivot of the blade, the blade angle of attack to the coning angle or the rise of each blade with respect to the hub, outside of the normal theoretical plane of rotation of a hub and blades of an autogyro rotor;

FIGS. 16-17 are perspective views of a launching and landing structure illustrating several optional developments in order to assist in launching and landing rotorcraft of systems in accordance with the invention, these systems providing an optional turntable to support turning the rotorcraft into the wind or allowing the vertical rudder vane of the rotorcraft to turn the rotorcraft and turntable into the wind to begin or terminate flight, this structural system also including a pivoting landing deck supported on the turntable to permit landing legs of the rotorcraft to contact the landing deck without requiring that the rotorcraft rotor change its angle of attack with respect to the incoming wind at landing, rather the rotorcraft can land at a particular angle suitable to the angles of the tether and rotary wing, after which the rotorcraft may be secured to the landing deck, and the landing deck may be tilted to an appropriate angle for storage, service, or the like;

FIG. 18 is a perspective view of an alternative embodiment of an autogyro system in accordance with the invention, illustrating the take-up system and a motor-generator system connected thereto, this take-up system also including a storage reel in order that rotorcraft may be drawn down to the ground, or flown down toward the ground, and may be disassembled, the rotors remaining threaded on the tether for compact storage, while the frames or fuselages of the rotorcraft may be removed for storage to a different location or a nearby location;

FIG. 19 is a perspective view of one embodiment of the rotorcraft of FIG. 18, illustrating more details of the connection scheme between the frame and the rotor;

FIG. 20 is a control scheme for managing tension in a tether of an invention of an apparatus in accordance with the invention; and

FIGS. 21A-21D are the top plan view of a frame of an autogyro, a side elevation view of the same autogyro, a front elevation view of the rotorcraft, and a perspective view of the rotorcraft, respectively, relying on a bridle system to both connect the tether to the rotorcraft for generating power, as well as to control the pitch, roll, or both of such an autogyro by drawing and releasing the bridle cords or lines that connect to the various and extreme aspects of the rotorcraft.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

Autogyro aircraft are described in considerable detail in U.S. Pat. No. 5,301,900 to Groen et al., which patent is incorporated herein by reference. Likewise, numerous patents to de la Cierva, Pitcairn, Barltrop and others are available in the records of the United States Patent and Trademark Office.

An autogyro typically develops lift from unpowered, freely rotating, rotary blades. In actual fact, the blade of an autogyro is a wing. The wing rotates or “windmills” in response to wind passing through the blade or wing from the underside thereof. As wind passes through the underside of the blade, the angle of the blades with respect o the wind results in the blades responding as sails, transferring momentum from the wind into the blade, turning the blade, and diverting the wind. As the wind is diverted, momentum corresponding to the change in direction and speed of the wind is transferred as momentum into the movement of the blade or wing.

The principle of an autogyro is the knowledge that the windmilling process of rotating the rotary wing or blades of an autogyro is sufficient to develop speed sufficient to invoke Bernoulli's principle. If the blade is made as more than a windmill, the blade may have a comparatively flatter under surface and a rounded airfoil shape on its upper surface. Accordingly, as the blade moves through the air, under the motivation of the wind passing through the blade from underneath the blade, the airfoil develops a reduced pressure along the upper surface thereof, developing lift to raise the blade.

A fixed wing aircraft is drawn through the air by a propeller, thus passing air over the fixed wing. Lift occurs by the drop in pressure that occurs as the wind flowing over the top of the wing accelerates to pass over the thickest portion of the wing. A rotary wing also develops lift by the relative motion of air or wind over the top thereof.

The drop in pressure results from the principles of conservation of energy as the air moves relative to the airfoil. Its total pressure head remains substantially constant. If the velocity changes, as it must in order to speed up to pass through a reduced cross-sectional area of flow, then the static pressure must drop in order to maintain head at a substantially constant value.

The curvature of the upper surface of an airfoil restricts the available cross-sectional area for the air movement to pass through, requiring the air to speed up, thus reducing its pressure to meet conservation of energy requirement. It is instructive to consider that the relative air speed of a rotating wing may be independent of the forward air speed of any body, fuselage, nacelle, frame, or the like.

Autogyro aircraft have been motivated by pusher propellers mounted near the rear of a fuselage, pushing the aircraft forward. The rotor disk, that is, the theoretical disk, is swept by the rotary wing, and is pitched at an angle that passes the incoming air up through the rotor disk. The rotor disk is tilted upward near its front extremity, and comparatively downward at its rear most extremity. Meanwhile, the actual angle of the blade itself with respect to the air through which the blade passes in its rotary motion, is set at some angle that will tend to minimize drag, while maximizing lift. “Blade pitch” is generally controlled or set at a position to “fly” through the air.

Probably the most significant discovery about autogyro aircraft is simply the fact that the relative airspeed of a blade or wing rotating in air may be uncoupled from the relative air speed of the overall system (fuselage, axis of rotation, or the like). Thus stall speed of the rotor blade at any point may be substantially different from relative ground speed of the fuselage of its rotorcraft.

Helicopters can actually hover. Autogyros, on the other had, can only hover in certain limited circumstances wherein their forward motivation from a motor or other mechanism is matched by an actual head wind speed relative to the earth that is naturally occurring. In this circumstance or while descending, an autogyro may hover or maintain position with respect to the earth. Nevertheless, a helicopter may hover in substantially any relative wind, including a still air situation.

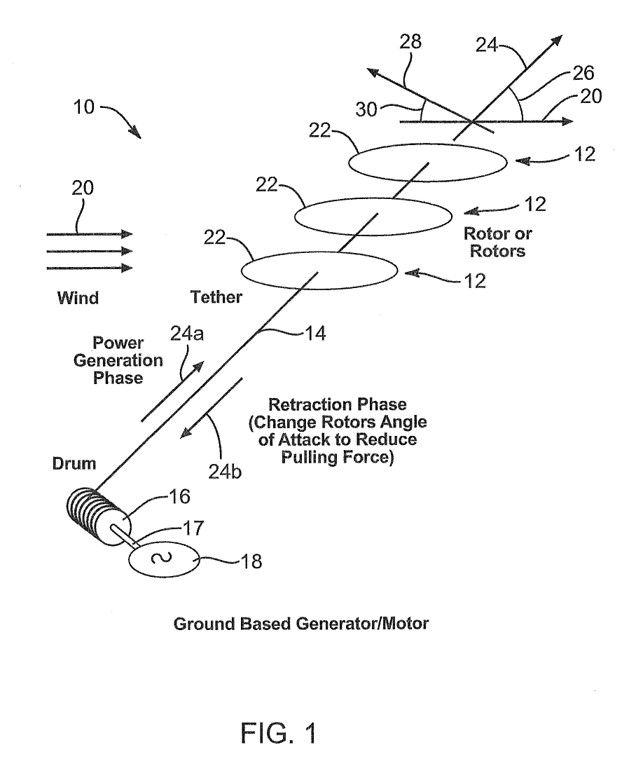

Referring to FIG. 1, while referring generally to FIGS. 1-21, an aircraft 12 or autogyro 12 may be secured to a tether 14. The tether 14 may be formed of a natural or synthetic material. In certain embodiments, a steel cable may serve as the tether 14. In other embodiments, synthetic polymeric fibers may be braided into ropes. One example is the Dyneema™ brand cord that may be braided into various diameters. Such materials provide extremely long life, durability, high strength, suitable wear characteristics, and substantially lighter weight than steel cables and the like.

The tether 14 may be taken up around a reel, spool, sheave, or the like. Such a reel or the like may be part of a take-up unit 16. The take-up unit may provide mechanisms for taking in the line of the tether 14 and laying it systematically and uniformly along a layer on a reel. Sophisticated technologies in the wire and cable industry, the design of all manner of fishing reels, and the like have dealt with the problem of reaving line onto a spool, pulley, or reel in a neat, orderly, and removable fashion.

A connection 17 may physically connect a take-up unit 16 to some form of converter 18, such as an electrical generator, a hydraulic motor, a compressor gases. It may be any other manner of converter than can suitably convert the energy provided rotatively from the drum, and converted to some other transmissible form, a storable mode, or both. In one embodiment, an electrical generator 18 may be a suitable converter 18 to convert the rotary power delivered by the take-up unit 16; through the connector 17 and converted into electrical power suitable for introduction back into the electrical grid of a local, state, or national electrical distribution infrastructure.

In operation, the system 10 may operate by flying the aircraft 12 upward against tension created in the tether 14. Accordingly, force, operating through a distance, creates energy. That amount of energy delivered over a period of time constitutes power. Accordingly, the connector 17 may deliver power to a converter 18 of a suitable type according to the tension in the tether 14, and the rotary or other motion of the take-up unit 16.

Thus, an aircraft 12 may be flown, by virtue of its lift and apply a force on the tether 14, which force is delivered as power according to the reeling out of the tether 14 by the take-up device 16 against the resistance of the converter 18.

The aircraft 12 may be retrieved by the tether 14, by operating the converter 18 in reverse. For example, in one embodiment, the convertor 18 may be a motor-generator apparatus. Such devices may be manufactured to operate as a motor when current is delivered to them. They operate as a generator when mechanical force is instead applied, while a load is connected electrically to draw the electricity off.

Thus, as in hybrid cars, and other electrical equipment, a converter 18 may be an appropriate type and size of motor-generator 18. This motor-generator 18 may selectively operate between a motor mode and generator mode. When in motor mode the motor-generator 18 rotates a connector 17 to drive the take-up unit 16 in retrieving the tether 14 against a modest life of the aircraft 12.

The aircraft 12 may be piloted, such as by an autopilot or other computerized control mechanism to fly the aircraft 12 upward against the load of the motor-generator 18, thus drawing maximum power deliverable in that mode. In the cyclically alternating portion of such a cycle or operation, the motor-generator 18 may operate at a motor, while the automatic controls on the aircraft 12 effectively fly the aircraft downward, maintaining only a minimal mount of tension of the tether 14.

Thus, the net gain of energy results from the comparatively larger tension in the tether 14 exerted by one or more aircraft 12 lifting on the tether 14 and thus applying a force thereto, in contrast to the comparatively light force maintained in the tether 14 as the one or more aircraft 12 are flown back closer to the earth in order to retrieve the tether 14 or the line 14 on the take-up device 16.

Thus, a comparatively large force is applied during payout of the tether line 14, providing power. A comparatively small amount of power is used in reeling in the tether line 14 on the take-up unit 16 in preparation for another lifting flight by the aircraft 12.

In the illustrated embodiment of FIG. 1, the wind direction 20 or the wind 20 may generally be thought of as operating parallel to the surface of the earth. This is not exactly true at all locations. Nevertheless, as a general proposition, winds move about the surface of the earth, and an aircraft 12 will typically be oriented to fly “into” the wind 20.

One mode of aircraft 12 may include a fixed wing aircraft. In one presently contemplated embodiment, a rotorcraft aircraft 12 may include a rotary wing, commonly referred to as a rotor 22. The rotor 22 operated by spinning in auto rotation. This is, the rotor 22 rotates in a substantially planar region or rotor disk 28. As a practical matter, some rotors 22 may have degrees of flexibility that permit the rotor 22 to literally operate in a somewhat conical configuration at times.

In general, a tether 14 may extend in a direction 24. The direction 24a represents the outward direction of reeling out the tether 14 or tether line 14 as the aircraft 12 operates in a maximum lift orientation to draw the tether 14 out from the take-up unit 16. Meanwhile, the direction 24b represents the direction in which the tether 14 moves as it is being taken up under minimum tension while the aircraft 12, or multiple aircraft 12, or caused to fly downward at minimum lift.

As a practical matter, the direction 24 may change slightly along the path. For example, the tether 14 does not have zero weight. Accordingly, the tether will not travel along an exactly straight line but may suspend as a catenary. Nevertheless, at any point along the tether 14, a direction 24 may be established.

The direction 24 also helps establish an angle 26 between the direction 24 of the tether 14, and a datum, such as the surface of the earth. In one embodiment, the wind direction 20 may establish an angle 26 with the tether direction 24. The angle 26, thus, defines a relationship with the relative wind direction 20.

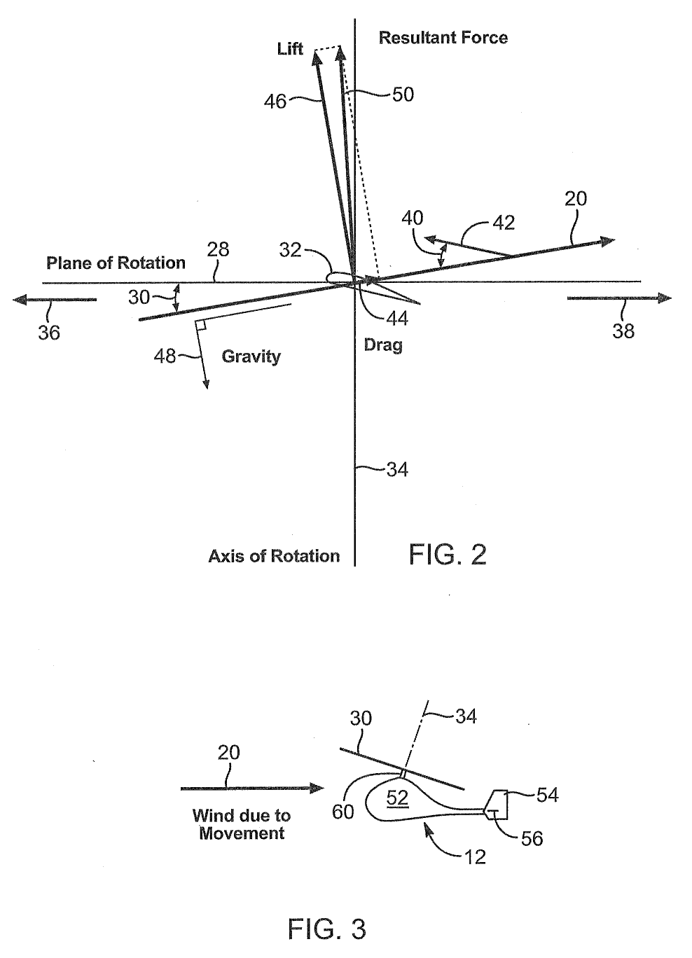

Typically, the rotor 22 and any rotor plane 28 established thereby will form an angle 30 with the wind direction 20. Thus, a rotorcraft relies on a positive angle 30 in order that the air pass up through the rotor, thus windmilling or autorotating the rotor 22. The autorotation of the rotor 22 by the wind 20 treats each blade 32 of the rotor 22 something like the wind will treat the sail of a boat. The net momentum transfer to the blade 32 by the wind 20 as the wind changes direction motivates the blade 32 to move in a direction opposite from the direction to which the wind is deflected. The blades 32 are shown in FIG. 2.

Thus, the rotation of the individual blades 32 of each rotor 22 gives to each blade 32 a net velocity. Each blade 32 is formed as an air foil. Accordingly, the Bernoulli effect operating over the upper surface of each blade 32 provides a reduction in air pressure with a consequent lift force on the blade 32. Thus, each rotor 22 is moved forward like a windmill by the wind passing upward through the rotor 22 from the underside thereof. Then the blade 32 generates lift as a consequence of the lift of the blade 32 through the air. The consequent Bernoulli effect reducing pressure on the upper surface of the blade 32 provides a lifting force.

Referring to FIG. 2, the blade 32 of a rotor 22 may be thought of as rotating, typically in a plane. As a practical matter, traveling in a plane referred to as a plane of rotation 28 or rotor disk 28, is not always a foregone conclusion. When a rotor blade 32 is traveling at a very low speed, the incoming wind 20 may actually alter the pitch of the blade 32, or the blade angle of attack 40. Thus, a rotor 22 if it relies on blades that are free to flap up and down throughout some range of motion on a hinge, may actually form something of a cone, rather than a plane.

Nevertheless, any point of a rotor blade may be thought of as rotating in a particular plane. Thus, when one views the blade 32 of FIG. 2, with its axis of rotation 34, the forward direction 36 in which the blade travels stand opposed to the retreating direction 38 that the blade travels in the course of its rotation.

Thus, the incoming wind 20 below the blade 32 results in a blade angle of attack 40 describing the very local pitch of the blade 32 with respect to he incoming wind. Blade angle of attack 40 may be thought of as the chord direction 42 with respect to the wind direction 20. That angle 40 establishes the blade angle of attack 40.

According to Bernoulli effect as described by the Bernoulli equation, the passage of the wind 20 over the top of the blade 32 results in a reduction of pressure on the upper side of the blade 32, thus generating a lift force. The lift force 46 acts upwardly while the wind 20 also asserts a certain amount of drag against the blade 32. Thus, the blade is subjected to a drag force 44 in a direction 20 of the wind 20, while the lift force 46 operates substantially perpendicularly thereto, tending to lift the blade 32.

In general, one may think of winds as operating within the nap of the Earth, and therefore operating substantially horizontally with respect to he Earth. In the illustration of FIG. 2, the force of gravity is not aligned with the axis of rotation 34 of the blade 32 and rotor 22. Rather, the gravitational force operates as shown, because the blade is typically oriented with a positive angle of attack 40 with respect to the incoming wind, which wind must come through the bottom side or face of the blade 32 or rotary wing 32.

The resultant force 50 becomes the net force on the blade 32, and the combination of the forces 50 on the various blades 32, whether 2, 4, 5, or more, then results in an ultimate force 50. One may note that the direction of flight of an aircraft 12 is generally against the incoming wind 20. This is for the same reason that the wind direction is substantially parallel to the Earth.

For example, an aircraft travels at an altitude with respect to the surface of the Earth. In a free flying autogyro aircraft 12 absent a tether 14, the net resultant force 50 is upward due to the lift force 46, but backward, contrary to the direction of motion, as a result of the drag force 44. In a free flying aircraft 12, the drag force is overcome by the force of a tractor motor in front of or behind the aircraft 12. Here, the tether 14 and the tension therein provide the force resisting both the upward lift force 46, and the drag force 44. Accordingly, the resultant force 50 is the force available to act to lift the rotorcraft 12, or other aircraft 12, and also to support tension in the tether 14.

Referring to FIG. 3, a rotorcraft 12, or other aircraft 12, may have a fuselage 52 or frame 52. For example, a frame generally provides the support of a load, equipment, and so forth. Meanwhile, such a frame when provided with a skin is often referred to as a fuselage. Nevertheless, we will use the terms frame 52 and fuselage 52 interchangeably.

In some embodiments, a frame 52 or fuselage 52 may include a vane 54 or rudder 54, and may include an elevator 56. Thus, the rudder operates as a vertical vane 54, while the elevator 56 operates as horizontal vane 56.

By mounting the rudder 54, the elevator 56, or both near one extremity of a boom 58, with the opposite end of boom 58 secured closer in to the frame 52 or fuselage 52, each of the vertical vane 54 and the horizontal vane 56 obtain greater leverage to orient the fuselage 52 or frame 52 with respect to the wind 20 and rotor 22. In certain embodiments, the rotor 22 may rotate on or about a mast 60. The mast 60 may operate to secure the rotor 22 to the fuselage 52.

Since the rotor 22 operates as a rotary wing 22, no power needs to be transmitted through the mast 60. Thus the rotor 22 may rotate on a bearing fixed at its inner race to the mast 60. Alternatively, the mast may be supported on a system of bearings so that the mast 60, itself is permitted to pivot or even rotate with the rotor blades 32.

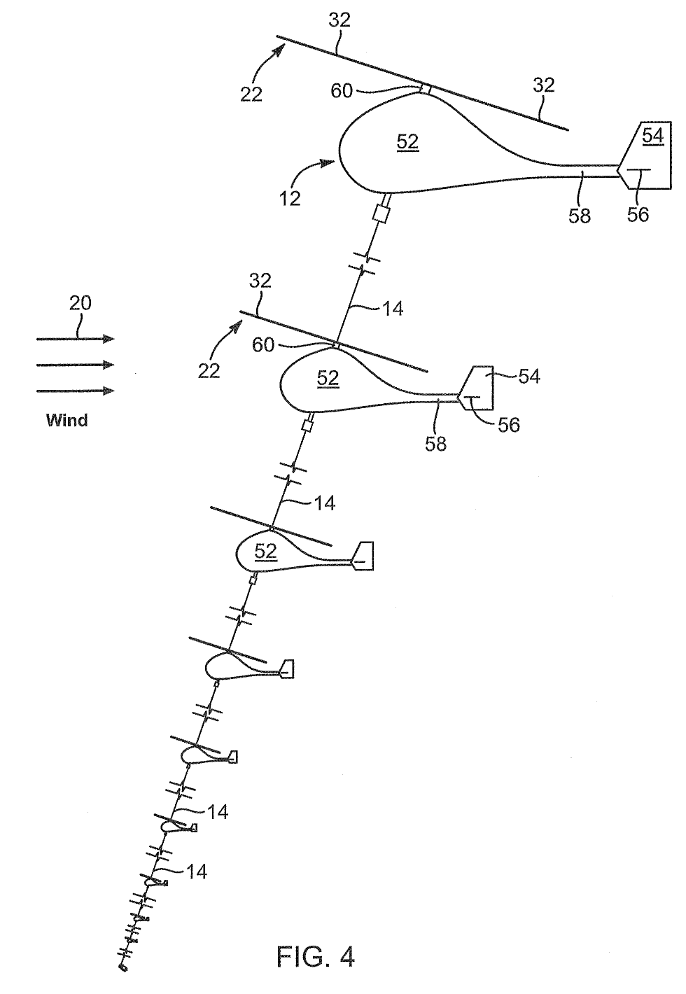

Referring to FIG. 4, while continuing to refer generally to FIGS. 1-21, multiple aircraft 12 may be connected to a long cable 14, line 14, or other type of tether 14. The various aircraft 12 may be “threaded” on to a tether 14. Each aircraft 12 may be flown aloft, by securement to the tether 14, and lifting by the previously lofted aircraft 12.

Typically, the blade angle of attack 40 for the blades 32 of each of the rotors, will be set at a sufficiently low or even negative angle of attack 40 to encourage autorotation. Thereafter, as the rotor 22 begins to turn at an appropriate rate, the blades 32 tend to extend straight out in a plane of rotation 28, with each blade 32 operating an the angle of attack 40 selected.

The angle of attack 40 of an individual blade tends to control the lifting force 46 applied by over flowing air to that blade. Nevertheless, the overall angle of attack 30 of the entire rotor 22 is quite a different matter. The increase in the angle 30 or rotor angle of attack 30 tends to increase the drag, by presenting a greater projected area of the rotor 22 to the incoming wind 20. Thus, in order to initiate autorotation, an aircraft 12 near the ground may be tilted to provide a greater angle of attack 30 corresponding to the entire area of the rotor projected onto the wind direction.

As a practical matter, the multiple aircraft 12 connected to the tether must each be lifted off or flown upward, after which another aircraft may be launched.

Referring to FIG. 2, an apparatus 10 may support a aircraft 12 may be set up along a horizontal surface, each could lift the subsequent one located beside it, as the relatively upward or higher adjacent craft 12 tensioned the tether 14 between itself and the next adjacent aircraft 12. Then the lower or comparably lower aircraft would be lifted up. Some difficulties with orientation, and the like may be solved by equipping platforms, launch mechanisms, or the like in order to maintain the proper orientation and minimize any sudden loads applied to aircraft 12.

Nevertheless, by controlling the rotor angle of attack 30, autorotation may be begun as the rotor 32 turns on a theoretical axis of rotation 34 that is exactly horizontal. It would effectively act as a windmill as used in earthbound systems. Thus, somewhere between a horizontal axis of rotation 34, and a vertical axis of rotation 34, should be a suitable startup angle 20 for a rotor 22 in order to begin autorotation driven by the incoming wind 20 therebelow.

As the rotor 22 increases its angular velocity, the blade angle of attack 40 may be reduced, and the rotor angle of attack 30 may also be reduced. In some embodiments, such as the “delta: rotor concepts, the rotor angle of attack 30 and the blade angle of attack 40 may be coupled. In other embodiments, the rotor angle of attack 30 is controlled completely separately from the blade angle of attack 40.

One can see that the municipality of aircraft 12 pulling against the tether 14 will apply a cumulative force equal to all of the total lifting forces 46, against all of the combined drag forces 44, thus providing a net resultant lift force 50 on the tether 14 as applied by all of the aircraft flying thereabove.

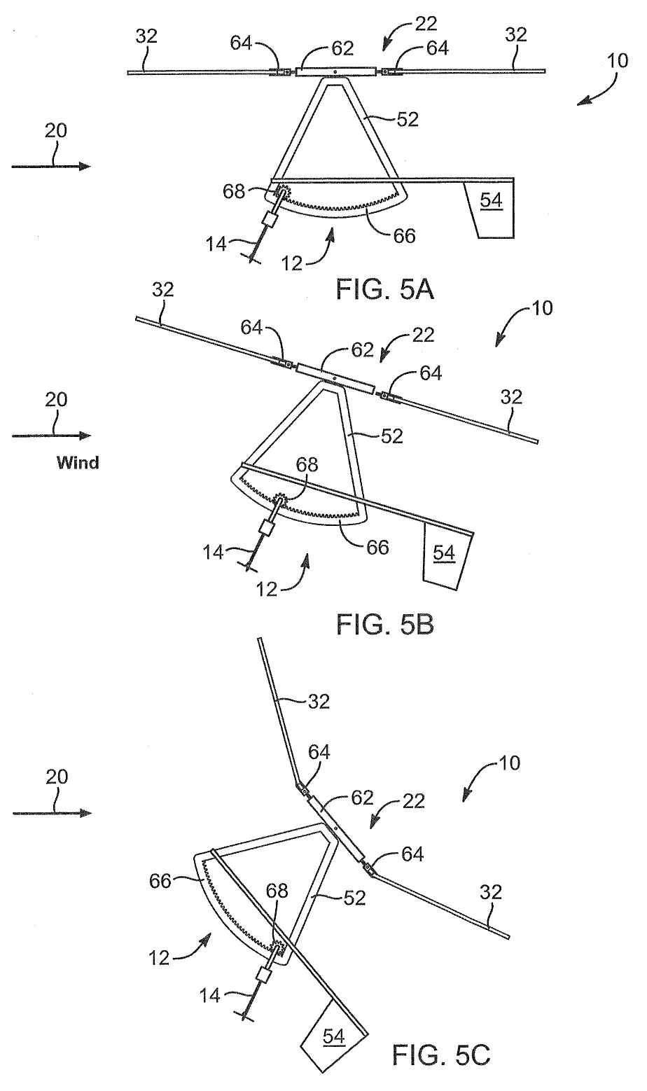

Referring to FIGS. 5A-5C, while continuing to refer generally to FIGS. 1-21, a rotorcraft 12 in one embodiment may be arranged or oriented by the pitching of the aircraft 12. For example, as illustrated in FIG. 5A the rotor angle of attack 30 may be brought down to a value of zero or less with respect to incoming wind. In this arrangement, the aircraft 12 will slowly drift out of the sky. The only lift force will be by virtue of rotation of the rotary wing 22 or rotor 22. Meanwhile, the only lift force will be the result of air passing over blades 32 of the rotor 22 as a direct result of the relative motion of the descending rotor 22. Also illustrated in FIG. 5A is a hub 62 operating to rotate with respect to the frame 52 or fuselage 52 of the aircraft 12. Meanwhile, pivots 64 between each of the blades 32 and the hub 62 provide a “flapping” motion of each hinged blade 32. Accordingly, each blade 32 may rise to any angle desired with respect to the hub 62.

The pinion 68 or spur gear 68 operates along a track 66 to change the pitch of the aircraft 12. In this embodiment, the pitch of the aircraft controls the orientation of the hub 62. Accordingly, the blade angle of attack 40, if coupled to the rotor angle of attack 30 will be affected by the pitching of the aircraft 12.

For example, referring to FIG. 5B, in the illustrated attitude, the incoming wind direction 20 passes wind 20 upward through the rotor 22. At a sufficiently high speed, centrifugal forces tend to stress the blades 32 and motivate them to extend exactly straight out from the hub 62. In the illustration at FIG. 5B, the wind 20 passes through the rotor 22 and its associated blades 32 in an upward direction. Thus, the incoming wind 20 tends to autorotate the blades. The blades, due to their selected blade angle of attack 40 or blade pitch 40 then begin to exert lift on the frame 52 as a direct result of the Bernoulli effect. The pinion 68 may be operated by a servo to travel along the track 66, thus orienting the rotor angle of attack 30 of the aircraft.

Referring to FIG. 5C, the rotorcraft aircraft 12 in one embodiment of a system 10 may actually be pitched with the rotor 22 in an extreme attitude. For example, hinged blades 32 may pivot at the pivot 64 shared with the hub 62. Accordingly, if the centrifugal force is small, due to the slow rotational speed, down to a zero rotational speed, then the drag force 44 acting on the blades 32 may “deflect” or lift the blades at the pivots 64 into more of a coning shape, rather than the familiar plane of rotation 28, and push them around like a windmill.

Thus, the pinion 68 operating along the track 66 may pitch the aircraft in a very steep attitude with respect to the incoming wind 20, thus causing the rotor 22 or the blades 32 to “windmill” or “autorotate.” In fact, in one embodiment, the rising of the blades 32 on the pivots 64 away from the frame 52 of the aircraft 12, may result in a changed angle of pitch 40 of each of the blades 32. Accordingly, in the absence of a positive angle of attack, the blades 32 may provide no net lifting force 46, while simply autorotating (like sails of a boat or windmill) in response to the momentum transfer from the incoming wind 20. As the rotational velocity or angular velocity of the rotor 22 increases, from the attitude of FIG. 5C to the attitude of FIG. 5B the blade 32 will have increased speed. Centrifugal forces will hold the blades 32 in full extension away from the hub 62 of the aircraft 12. In the illustrated embodiment of FIG. 5, the rudder 54 may operate to orient the frame 52 and thus the rotor.

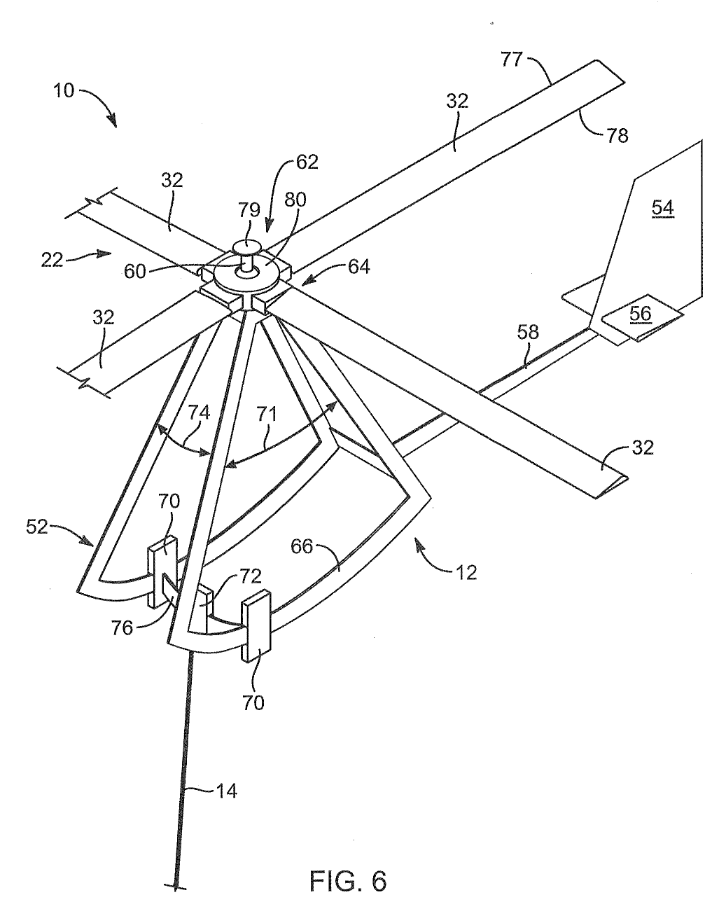

Referring to FIG. 6, while continuing to refer generally to FIGS. 1-21, another embodiment of the apparatus 10 or system 10 in accordance with the invention may rely on a pitch controller 70 operating along each rail 66. The rail 66 may be provided with teeth, or may be smooth. In either event, rollers or pinions 68 within the drivers 70 or controllers 70 may operate to move the controllers 70 back and forth along the rails 66 of the frame 52.

Meanwhile, rather than relying exclusively on the rudder 54 pivoting the aircraft 12 with respect to the tether 14. The tether 14 may connect to another controller 72. The roll controller 72 may operate on a track 76 extending between the pitch controllers 70. Thus, the frame maintains an angular spread 71 or a particular angle 71 between front and rear portions of the frame 52 Likewise, between right and left portions of the frame 52 may be an angle 74 through of as spreading angle for roll control. Likewise, the spread 71 or angle 71 establishes the length or the circumference of the track 66 that may be used for pitch control.

By the same token, the angle 74 may be established at some suitable value to provide the degree of a roll control by the roll controller 72 operating along the roll track 76. In the illustrated embodiment, the blade pitch angle 40 or blade angle of attack 40 may be established independently from any other rotor angle of attack 30 that may be set for the aircraft 12.

In the illustrated embodiment, the blade angle of attack 40 may be set for each blade 32 in order to assure that the rotor 22 will autorotate. Thereafter, the blade angle of attack 40 may be increased to a net positive angle with respect to the incoming wind 20 against the leading edge 77 of a rotating blade 32, when the blade 32 is advancing forward in the same direction of the flight of the aircraft 12.

Where the aircraft 12 may be tethered to a tether 14, then the advancing blade 32 will have a leading edge 77 flying into the incoming air stream. Meanwhile, another blade 32 will be a retreating blade 32, retreating with a different relative wind, because the net relative air speed of the blade 32 is a combination of the speed of the aircraft 12 with respect to the incoming wind 20 plus the respective velocity of the advancing blade 32 with respect to the frame 52.

Similarly, the retreating blade 32 is traveling in the retreating direction 38 illustrated in FIG. 2. Thus, the aircraft velocity may be positive with respect to the incoming wind 20, while the blade velocity is negative with respect to the aircraft.

In the illustrated embodiment, the rudder 54 and the elevator 56 may be used to orient or trim the aircraft 12 to fly into the wind. Nevertheless, the roll control 72 may be used to control the side-to-side attitude of the aircraft and its associated rotor 22. Meanwhile the pitch controllers 70 may operate along the rail 66 to establish the rotor angle of attack 30 of the aircraft. As state, the embodiment of FIG. 6 may include a controller either within the rotor, ar attached to the rotor 62 in order to individually alter the blade angle of attack 40 of each individual blade 32.

The rotor 62 may be secured to a mount structure, such as a mast 60. In certain embodiments, the mast 60 may be formed to have a spherical bearing, bushing, or journal within the main bearing assembly of the rotor 62. Thus, in certain embodiments, the rotor 62 may stand off away from the frame 52 of the aircraft 12, and permit the rotor 22 to seek its own suitable angle of roll.

For example, because the leading edge 77 tends to operate at a higher relative velocity with respect to the incoming wind 20, it will tend to climb faster or fly upward to a greater extent. The relative wind velocity with respect tot eh forward moving or advancing blade 32 is the velocity of the aircraft 12 with respect to the wind 20, plus the relative velocity of the blade 32 with respect to the aircraft frame 52. Thus, the forward speed of the aircraft 12 adds to the forward speed of the rotating, advancing blade 32.

In contrast, the retreating blade 32 has a net velocity with respect to the incoming wind 20 of the forward speed of the aircraft from 52, minus the linear velocity (angular velocity at a radius) resulting from the retreating blade. As a practical matter, the retreating blade relative velocity with respect to the aircraft 12 is a speed in a backward direction. It is thus subtracted from the forward speed of the aircraft frame 52. Thus, the rotational velocity of any point on each blade 32 is added to (for an advancing blade) and subtracted from (for a retreating blade) the forward airspeed of the frame 52 of the aircraft 12. Thus, the advancing blade 32 will tend to climb higher, while the retreating blade will tend to climb lower. There is a tendency for the rotor disk 22 to roll to a particular attitude with respect to the frame 52 that will leave the advancing blade extending upward at a higher angle, with the retreating blade extending downward at a lower angle with respect to the mast 60.

A mount 79 on top of the mast 60 may provide a platform for mounting various control equipment, communications equipment, and the like. For example, certain blade pitch 40 control mechanisms may be connected to the mount 79. In other embodiments, such blade pitch control mechanism may be connected directly to the rotor 62 in order to rotate with the rotor 62 and the blades 32.

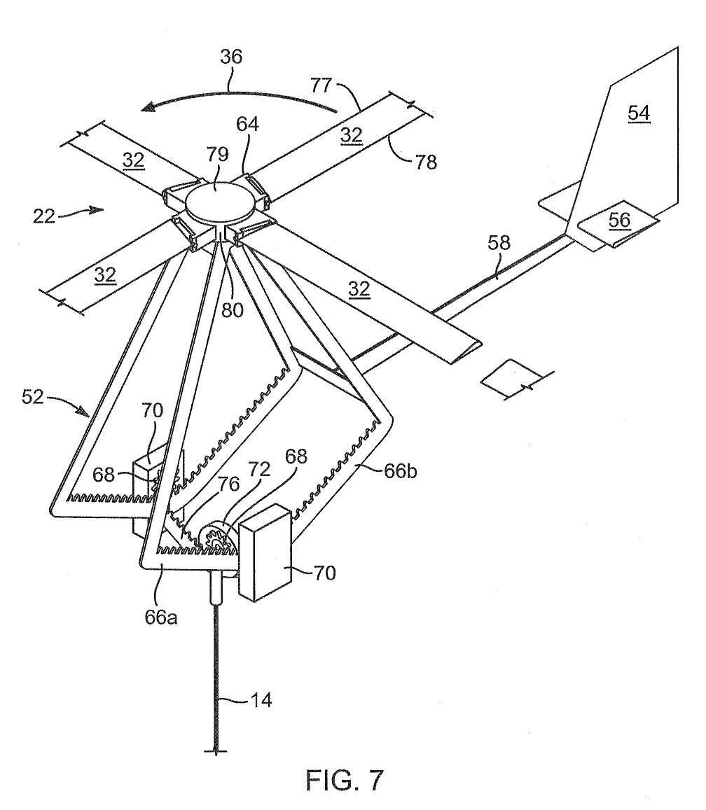

Referring to FIG. 7, in one embodiment of an aircraft 12 in accordance with the invention, the track 66 may have a forward portion 66a, and an aft portion 66b. Between the fore 66a and the aft 66b portions of the track 66, may be a detent or depressed area having a much smaller radius. Thus, the frame 52 of the aircraft 12 may have a preferential position, favoring that particular orientation when restrained by a tether 14. As with the embodiment of FIG. 6, the embodiment of FIG. 7 has a leading edge 77 and a trailing edge 78 for each of the blades 32. The leading edge 77 tends to be comparably bluff. By contrast, the trailing edge 78 tends to be very thing and sharp. This arrangement is dictated by the aerodynamics of an airfoil, particularly one that must provide lift, while minimizing drag.

Similarly to the embodiment of FIG. 6, the controllers 70, 72 may include appropriate wheels 68, pinions 68 or the like to operate along the tracks 66. Nevertheless, in this embodiment, the preferential “low spot” in the track 66 tends to leave the aircraft with a preferred position, maintained long term. Or course, the favored position may be overridden by operating the controllers 70, 72 in order to pitch the frame 52 and consequently the rotor 22 at a different angle with respect to the incoming wind 20.

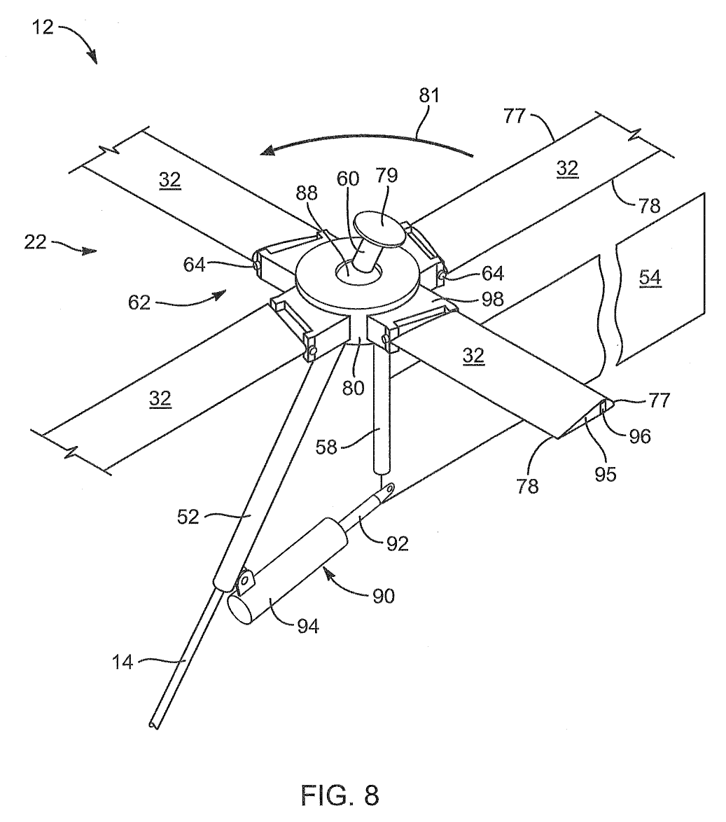

Referring to FIG. 8, in another embodiment, a delta type of hinged rotor 22 may employ pivots 64 between the hub 62 and the blades 32. By construction each of the pivots 64 to extend along a path that is canted with respect to a radius extending from the center of the hub 62, the rotor angle of attack 30 may be coupled to the blade angle of attack 40.

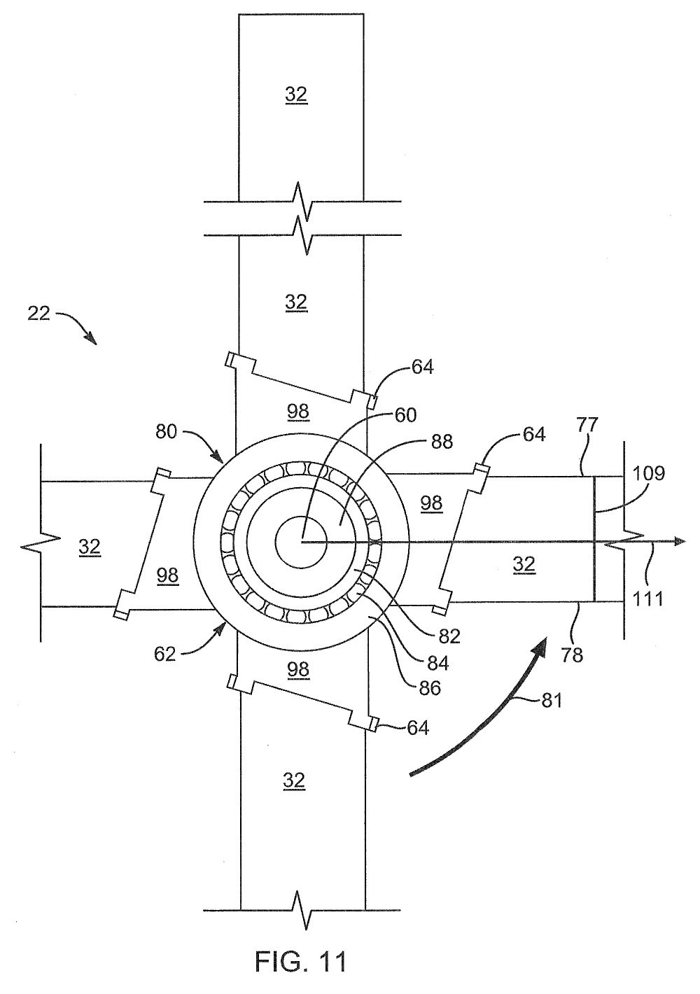

In general, a rotor 62 for a rotorcraft may include a bearing that provides reduced friction between the rotation of the rotor 62 and the mast 60. As a practical matter, most bearings will have an inner race 82 substantially fixed with respect to the rotation or lack thereof of the mast 60 (see FIGS. 11-14 for the details of the bearings). There, an inner race 82 does not need any appreciable rotation with respect to the mast 60. Meanwhile, the bearing rollers, whether they be thrust bearing rollers, ball bearings, Timken™ bearings, or the like may operate between the inner race 82 and the outer race 86 containing them.

Therefore, in general, a bearing may operate as an outer race 86 rotating abut an inner race 82, while rollers 84 roll therebetween. In alternative embodiments, an inner race 82 may rotate, while an outer race 86 remains fixed, while the bearing rollers 84 roll therebetween reducing the friction of the relative motion. In the instant case, where a rotor 22 operates about a mast 60 substantially fixed with respect to an aircraft frame 52, the outer race 86 moves with respect to the frame 52, while the inner race 82 remains substantially fixed with respect to the mast 60. Nevertheless, in certain embodiments, a spherical bearing may permit the pivoting of a rotor hub 62 in order to accommodate the necessary roll angle for the tendency of the advancing blade 32 to fly up and the retreating blade 32 to fly down with respect to one another.

Referring to FIG. 8, the direction 81 of rotation of a rotor 22 may present the rotation of the individual blades 32 in the rotational direction 81. In an attitude of initial flight, at slow speed, the individual blade 32 may lift upward or away from the ground or tethered direction on the pivots 64. One may note that in the embodiments of FIGS. 7-9 the rotor 62 includes a mount 88 on the mast 60 to which the bearing 80 is substantially secured. The mount 88 may be fabricated as a spherical bearing or pivot, about which the bearing 80 may pivot, but not rotate.

Meanwhile, as the rotor angle of attack 30 is initiated, a comparably slow rotation by the rotor 22 may result in the drag forces 22 acting against the rotor blades 32 to lift them away from the tether 14. Thus, the pivot of the blade 32 about the pivot 64, both a blade angle of attack and a rotor coning angle are affected.

For example, upon the lifting of the tip of any blade 32 with respect to the rotor 62, the blades 32 would then rotate in a conical sweep rather than a planar sweep. However, as one can readily see, whenever a blade 32 pivots about a pivot 64, the angle formed between a radius and the axis of one of the pivots 64 results in a certain twist or change in the blade angle of attack 40 of each blade 32. Thus, any tendency of a blade 32 to fly up, or to be drifted up by the drag forces 44 of the incoming wind 20 will tend to decrease the blade angle of attack 40, thus increasing the net momentum transfer of the incoming wind 20 put into rotation or auto rotation (sometimes called windmilling) of the blades 32 and the rotor 22.

In the embodiment of FIG. 8, and actuator 90 may include a movable element 92, and a housing 94 substantially fixed with respect to the frame 52 of the aircraft 12. Here, the frame 52 is little more than a mere tube secured about the tether 14. Thus, the actuator 90 by extending the movable element 92 may rotate a boom 58 fixed to the inner race 82 of the bearing 80. Accordingly, the inner race 82 may be pivoted with respect to the mount 88, thus changing the pitch 30 of the entire rotor 22.

Actually, the rotor angle of attack 30 may be modified by pitching the bearing 80 and the rotor 62. When the rotor hub 62 is pivoted about the mount 88, or when the entire aircraft frame 52 is pivoted as in FIGS. 5-7, in the pitching direction or to modify the rotor angle of attack 30, then the wind may present more drag against the underside of each of the blades 32. Meanwhile, a vertical vane 54 such as a rudder 54, or the like may also be connected to the frame. Thus, the vane 54 may maintain the orientation of the aircraft 12 represented by the frame 52 and rotor 22 into the prevailing wind.

Typically, the profile 95 or cross-section 95 of an individual blade 32 may include a spar 96 extending along the length of the blade 32. A spar 96 provides stiffness against bending forces within the blade 32. In certain embodiments, the blade profile 95 or cross-section 95 may be solid. However, in most aircraft, the blade 32 is necessarily hollow to minimize weight. Thus, a spar 96 may appropriately bi-sect or otherwise subdivide or cross the chord of the airfoil that is in blade 32.

The chord represents a line-extending from the leading edge 77 to the trailing edge 78. The stiffness of the blade 32 along the chord is generally build into the skin, ribs, and so forth of a blade 32. By contrast, the bending forces typically require a spar 96 to support the bending loads that will otherwise be imposed by the lifting force 46 acting on the upper surface of each blade 32.

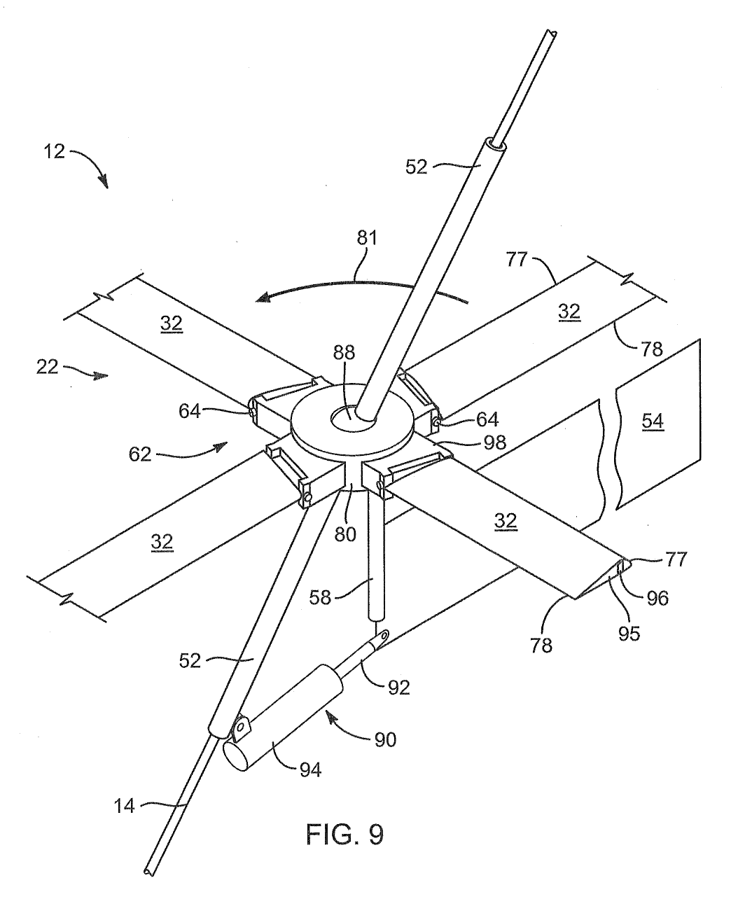

Referring to FIG. 9, in some embodiments, an aircraft may be threaded on the tether 14 in series along the length thereof. A suitable length of the tether 14 may separate adjacent rotors 22. Nevertheless, a frame 52 may be constituted by a simple tubular structure fitted over the tether 14, and fixed thereto in order to secure the aircraft 12 in applying tension to the tether 14.

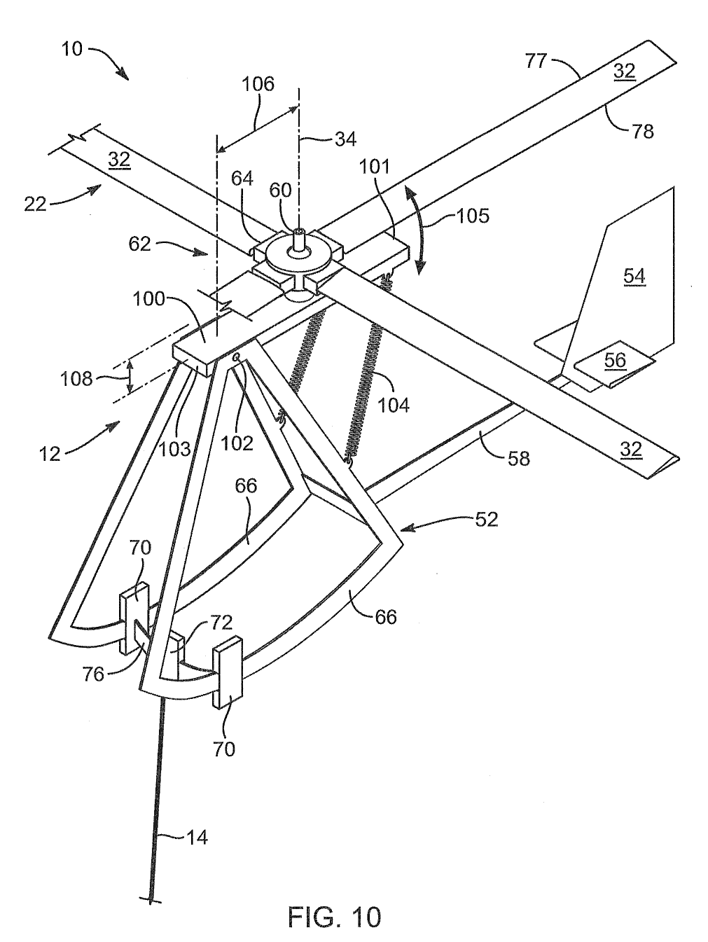

Referring to FIG. 10, a frame 52 of an aircraft 12 may be provided with a platform 100. The platform 100 in previous embodiments is hardly visible at the top of the frame 52. The small fraction of the upper platform, fixed to the remaining structures of the frame 52 can be seen below the rotor hub 62.

By contrast, the embodiment of FIG. 10 may include an elongated platform 100 extending from a front end 103 to a back end 101. Thus, the region of the platform 100 near the front end 103 may pitch about a pivot 102. Thus, the pitch angle 30 or the rotor angle of attack 30 may be modified, without necessarily pitching the angle or attitude of the frame 52 of the aircraft 12. A bias element 104 such as a spring, resilient member, mechanical or hydraulic actuator, servo or the like, may operate to urge the platform 100 into a particular attitude with respect to the remainder of the frame 52.

For example, a stop on the frame 52 may restrain the platform 100 from dropping below a substantially horizontal position as illustrated in FIG. 10. However, against the resistance or urging of the bias members 104 or springs 104, the back end 101 of the platform 100 may lift away from the remainder of the frame 52 in order to change the rotor angle of attack 30 established by the axis 34 of rotation about which the rotor 22 rotates.

One may see that the platform 100 extends away from the pivot 102, placing the axis of rotation 34 at a distance 106. This distance or length (L) 106 represents the offset 106 between the pivot 102 through which the axis of rotation 34 would normally pass in the frame 52 and the actual axis of rotation of the rotor 22. Meanwhile, the circumferential extension direction 105 of the pivoting of the platform 100 may cause a vertical offset 108 at the center of the plane of rotation 28 of the hub 62 and rotor 22 with respect to the pivot 102. This distance 108 in which the place of rotation 28 has been displaced above the pivot 102 or the neutral position or horizontal position of the platform 100 may be through of as a vertical offset distance 108 (D). The proportion of lift to drag of the rotor 22 is reflected in the ration of the distance (L) 106 with respect to the distance (D) 108. Thus, the ratio of lift to drag is in the same proportion as the length 106 offset to the vertical displacement offset 108.

One mor more actuators may operate as subsystems in the block 100 to control the distances 106, 108. In other embodiments, the rotor 22 may simply come to an equilibrium position for the distance 108 in response to setting, manually or by servo, the distance 106.

Referring to FIGS. 11-14, various embodiments of a hub 62 and the pivots 64 may be employed Likewise, various other accessories may be implemented in an aircraft 12 in accordance with the invention. For example, in the embodiment of FIG. 11, a rotor 22 rotating in the direction 81 includes the leading edge 77 that actually pivots at a smaller radius than the trailing edge 78. This is because the pivot is canted, rather than being perpendicular to a radius from the center of the hub 62. One may run a radius from the center of the hub 62 along each of the blades 32. The chord 109 of each blade 32 will lie perpendicular to that radius 111.

Thus, because the angle of the pivot 64 is not parallel to the chord, then the radius from the pivot 64 to the chord 109 is shorter along the leading edge 77, and longer, comparably, between the pivot 64 and the chord 109 along the trailing edge 78. Thus, one can see that the chord 109 changes its blade angle of attack 40 as the blade 32 pivots about the pivot 64.

Whenever, the blade 32 pivots upward (out of the page) with respect to the pivot 64, and the hub 62, the leading edge 77 operates on a smaller radius or distance between the pivot 64 and the chord 109. Thus, in an upward motion (out of the pate) the trailing edge 78 tends to sweep through a greater distance corresponding to a larger radius between the chord 109 and the pivot 64.

This operation provides for greater negative angle of attack when the blades 32 are coned upward from the hub 62. A lower angle of attack 40 for each blade 32 will exist when each blade 32 is spinning flat in a plane passing through the hub 62. Thus, the blade angle of attack 40 is coupled to the pivoting of each blade 32 with respect to the pivot 64 and the hub 62.

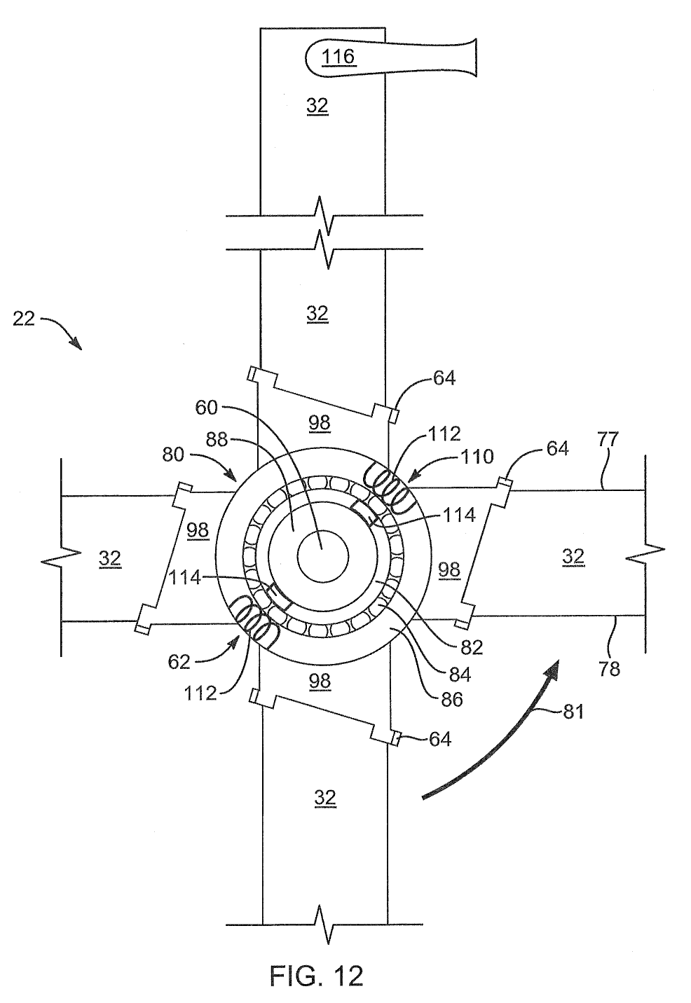

Referring to FIG. 12, in certain embodiments, a generator 110 may provide operation power such as the electrical power needed to operate instrumentation and control equipment associate with an aircraft 12, and its autogyro rotor 22. For example, power for operating a autopilot to fly an aircraft 12 up or down may be provided by onboard electricity from a generator 110. A generator 110 may be implemented by placing a coil 112 fixed with respect to one race 82, 86, and a magnet attached to the opposite race 86, 82. As a practical matter, the magnet 114 may actually be a wound electro-magnet 114 or a permanent magnet 114. Meanwhile the windings 112 may be passed through the magnetic field created by either type of magnet 114 to create electrical current in the winding 112. Thus, the generator 110 may provide some amount of power to a local battery or the like in order to power various instrumentation, controls, and the like on an aircraft 12.

In certain embodiments, it may be valuable to provide emergency power for launch, landing in undesirable conditions, or the like. Accordingly, jets 116 may be placed near the extreme outer ends of the blades 32. A jet 116 may be activated by remote control from a ground station if necessary to spin up a rotor 22 of an aircraft 12, temporarily fly a particular aircraft 12 with its rotor 22 downward in a non-wind condition, or the like.

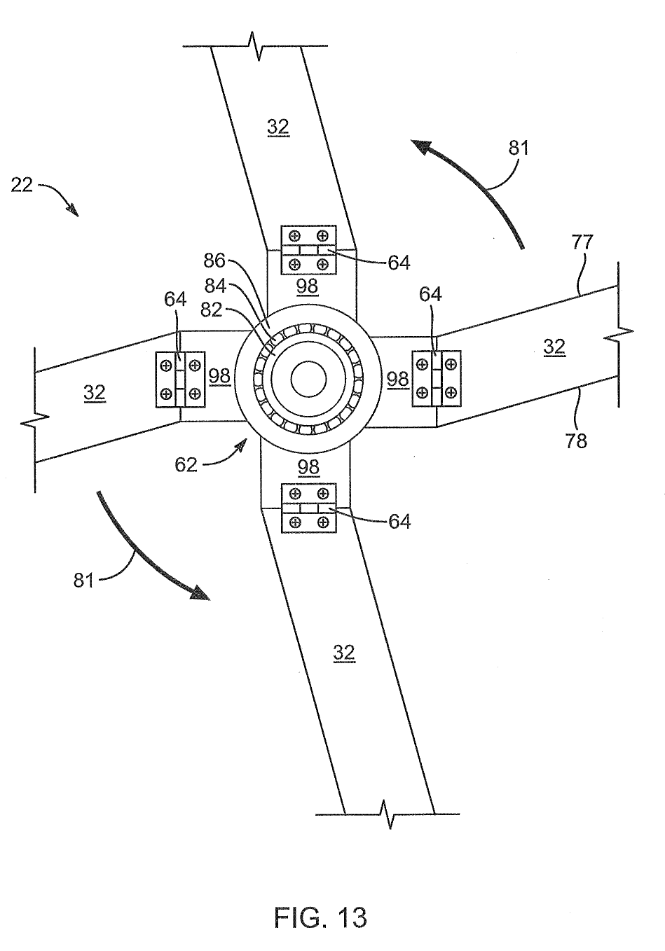

Referring to FIG. 13, while continuing to refer generally to FIGS. 1-21, one embodiment of a rotor 22 in accordance with the invention may include a pivot 64 secured to a blade 32 that is itself extending away from the hub 62 but not along a radius. For example, in the embodiment of FIG. 13, the blades 32 themselves actually rely on a pivot 64 that extends perpendicularly across a radius 111 from the center of the hub 62. As a practical matter, such a blade 32 creates a bending stress as centrifugal forces attempt to “straighten” the blade 32 along the radius 111. The pivot 64 and the entire length of the blade 32 must resist such bending forces acting to align the blade 32 with a radius 111.

In this case, the leading edge 77 again operates at a shorter value of a radius 111 from the center of the hub 62 compared to the trailing edge 78. Accordingly, this configuration operates like that of FIGS. 11-12 in which the coning angle or the tendency of a blade 32 to lift up and operate in a conical configuration rather than flat planar configuration thus effects a change in the blade angle of attack 40 by virtue of such pivoting of the blades 32 about the pivots 64.

In this case, the stub 98 or anchor 98 to which each blade 32 is connected by the pivot 64, extends as a fixed element rigidly secured as a part of the hub 62.

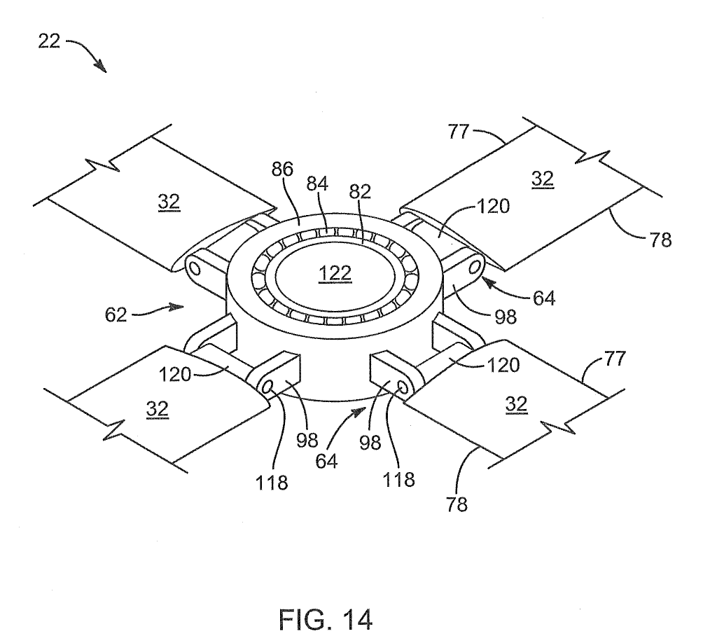

Referring to FIG. 14, as with the embodiments of FIGS. 5-13, the anchors 98 are fixed to the hub 62 and rotate therewith. Meanwhile, a pivot 64 pivotably secures each blade 32 to an anchor 98. A pin 118 may extend through each anchor 98 to secure a trunnion 120 fixed to each blade 32. In the illustrated embodiment, the pins 118 may extend along a direction perpendicular to a radius 111 through the center of rotation or axis or rotation 34 of each hub 62.

Likewise, a rotor 22 may be formed to tilt about a mast 60, and may be adapted to secure to a mount 88, such as a spherical bushing 88 or spherical ball connector 88. Accordingly, the rotor angle of attack 30 of a rotor 22 may be controlled independently from angle of attack 40 of the blades 32.

In an alternative embodiment, the pivots 64, and particularly the pins 118, may extend at an angle with respect to a radius 111 from the center of the hub 62, thus providing a coupling between any coning or lifting of each blade 32, and the respective blade angle of attack 40 of that blade 32. Likewise, the pivots 118 may extend perpendicularly with respect to a radius 111 of the hub 62, while the blades 32 may extend at a canted angle, just as the blades of the apparatus of FIG. 13.

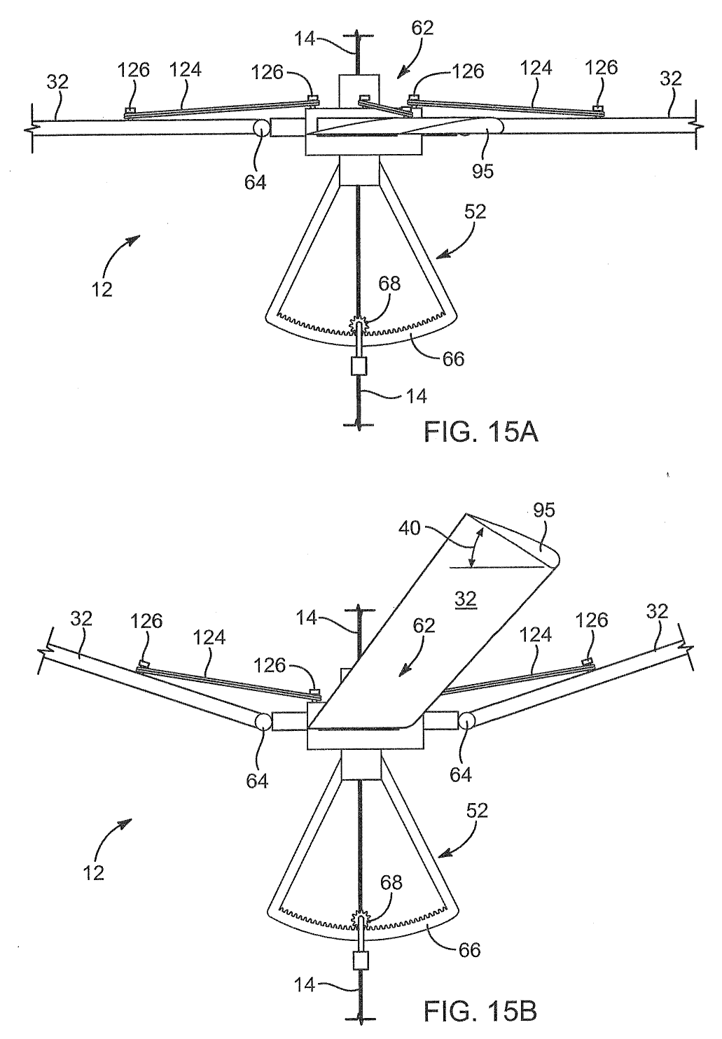

Referring to FIGS. 15A-15B, one embodiment of an aircraft 12 may include a frame 52 secured to a tether 14. Meanwhile, servo-controlled pinions 68 may operate along tracks 66 (a single track 66, multiple tracks 66, or the like) in order to pitch the frame 52 with respect to the tensioned tether 14 securing the aircraft 12 with respect to a ground station or the ground generally. In one embodiment, bias elements 124 such as springs 124, extensible bands 124, or the like may operate to lift the blades 32 to an attitude as illustrated in FIG. 15B.

With the pivots 64 as described with respect to FIGS. 11-14, the blade angle of attack 40 may be negative when the blade 32 is in the comparatively higher position of FIG. 15B. Meanwhile, the cross-section 95 of the blade 32 of FIG. 15B is flying with a negative angle of attack 40 with respect to the configuration of FIG. 15A. Meanwhile, in the configuration of FIG. 15A, in response to centrifugal force, the blades 32 descend and operate in a place about the axis of rotation 34 of the hub 62. In this case, the tether 14 is shown as passing through the hub 62. As a practical matter, the tether 14 may terminate at the frame 52, or terminate at the hub 62, with a single aircraft 12 on a tether 14.

Centrifugal force overcomes the bias of the bias elements 124, connected between the hub 62 and the blade 32 by bollards 126 or other attachment mechanisms 126. Centrifugal force overcomes the biasing force of the bias elements 124, thus causing the blades 32 to operate in substantially a planar configuration. In this configuration of FIG. 15A, the blade angle of attack 40 may be at its most positive value.

By contract, in the low speed configuration, when the blade is just starting up from a stationary or non-rotating position, when the aircraft 12 speed is sufficiently slow, or the speed of rotation is sufficiently slow, then each of the blades 32 may be lifted up by a bias element 124. This provides a situation wherein the wind 20 itself is not totally responsible to increase the coning angle or the coning of the rotor 22, but the bias elements 124 will so do automatically whenever the speed is insufficient to generate the centrifugal force required to flatten out the blades 32.

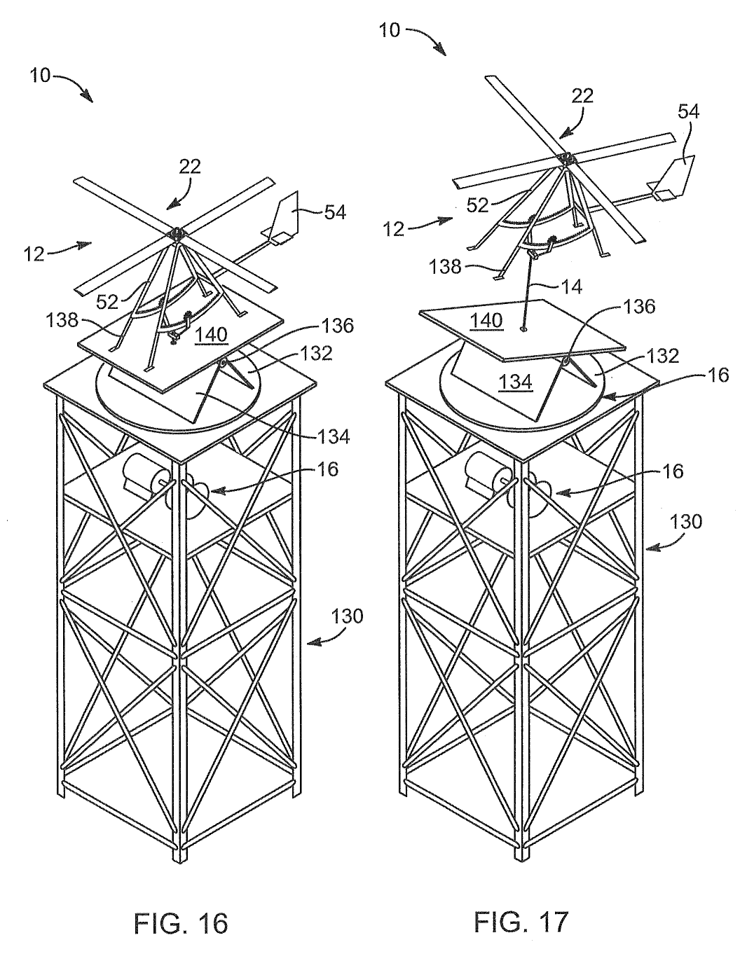

Referring to FIGS. 16-17, in one embodiment, a structure 130 may support a turntable 132. The turntable 132 may be supported on bearings reducing friction such that the rudder 54 of an aircraft 12 may generate sufficient rotational load to orient the aircraft 12 into the wind 20.

Regardless of whether or not a turntable 132 is relied upon, a standoff 132 may elevate a pivot 136 above the level of the turntable 132. On the pivot 136 the deck 140 may be passively or actively controlled to change its attitude (angle) with respect to horizontal.

For example, in FIG. 16, an aircraft 12 may sit at rest on the deck 140 supported by legs 138 or feet 138 extending from the frame 52. The legs 138 may be a part of the frame 52 or may be extensible, permanent, retractable, or the like. Meanwhile, however, upon launching or landing, the deck 140 may be tilted to provide the desired rotor angle or attack 30 desired to initiate or terminate flight. By the elevation of the structure 130, the aircraft rotor 22 may be placed above the surface of the earth. Thus, the aircraft 12 may be launched by tilting the deck 140 to provide a greater rotor angle or attack 30 and thus launch the aircraft. Meanwhile, during landing, a similar process may occur.

For example, the tether 14 may draw the aircraft 12 downward, while the control systems discussed hereinabove fly the aircraft 12 down by changing the rotor angle of attack 30, the blade angle of attack 40, or both. As the aircraft is flown down, a reduced force or tension in the tether 14 is experienced. The take-up unit 16 requires less energy output to retrieve the aircraft 12 than the energy generated by the aircraft when it is lifting the aircraft 12 against the tether 14, and producing maximum tension in the tether 14.

As the aircraft 12 approaches the deck 140, the legs 138 may touch the deck 140, and orient the deck to the aircraft 12, or orient the aircraft 12 to the orientation of the deck 140. Ultimately, the deck 140 may be leveled for storage, maintenance, or the like.

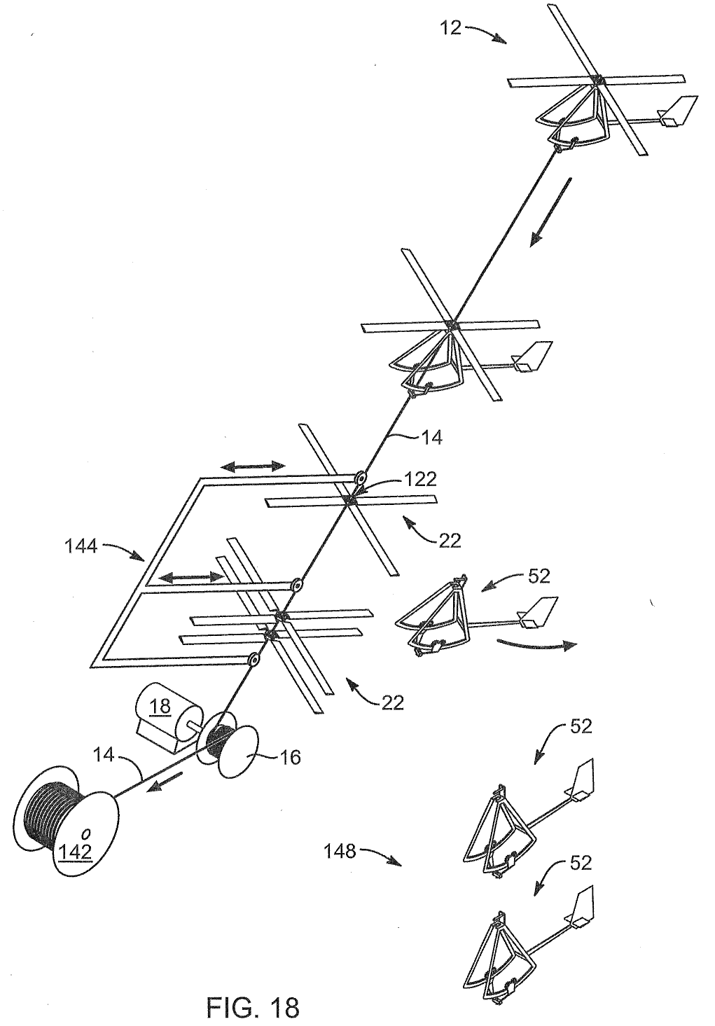

Referring to FIG. 18, in one embodiment, rotors 22 may be separated from their frames 52 at a ground station. For example, the take-up unit 16 may actually retrieve line, which is then stores in a storage device, such as a rope tank (e.g., operating like a climbing rope bag), storage reel 142, or the like. Meanwhile, a staging mechanism 144 may provide for selective removal of each aircraft frame 52 from its associated rotor.

The rotors 22 may then be stacked, each now free to pass the tether 14 through the center aperture 122 of the hub 62 thereof. Thus, the rotors 22 may be stacked one against another or one very close to another and separated by padding or the like, rather than being separated by hundreds or thousands of feet of the tether 14 used in operation.

The aircraft 12 may be redeployed by flying an aircraft 12 upward, fixing frames with respect to the tether, and flying each aircraft 52 with its own rotor 22 upward to the next distance of separation for another aircraft 12 to be attached. Thus, multiple aircraft may produce the net total lift available from each, to provide a net increase in tension in the tether 14.

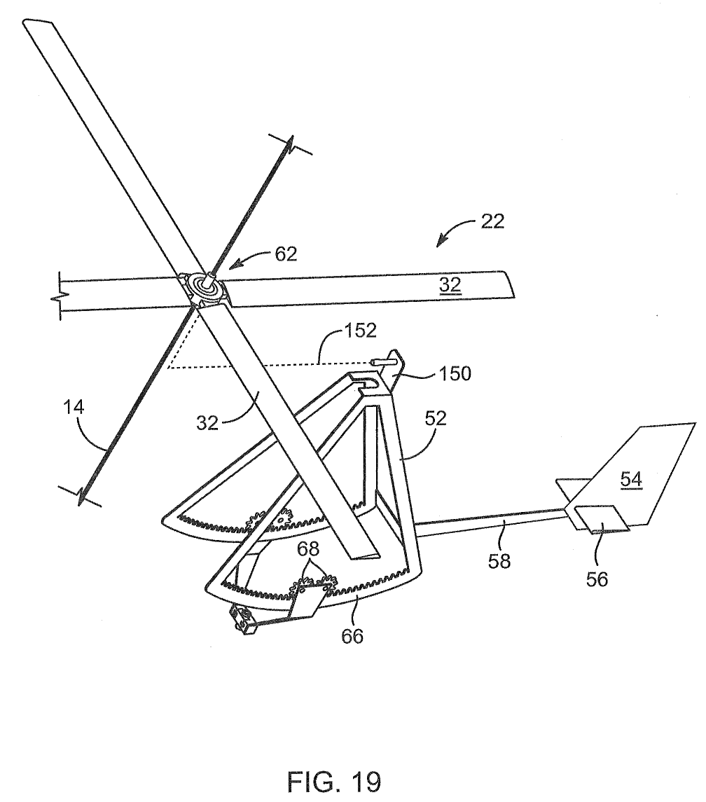

Referring to FIG. 19, the frame 52 may provide a capture mechanism, such as a connector 150 or adaptor 150 adapting each of the frames 52 to connect to the hub 62 of a rotor 22. The adapter 150 or connector 150 may be connected along the path 152 to secure the frame 52 to the hub 62. Meanwhile, the frame 52 may then be selectively fixed with respect to the length of the tether 14, in order to operate the rotor at a location that will appropriately tension the tether 14. The particular embodiment illustrates two pinions 68 servo-controlled to operate along each of the tracks 66.

As a practical matter, the aircraft 12 may operate as a platform for various instrumentation. For example, meteorological data may be collected at comparatively high altitudes of tens of thousands of feet above the surface of the earth. Thus, comparatively reliable and long term data may be obtained by instrumenting the aircraft 12.

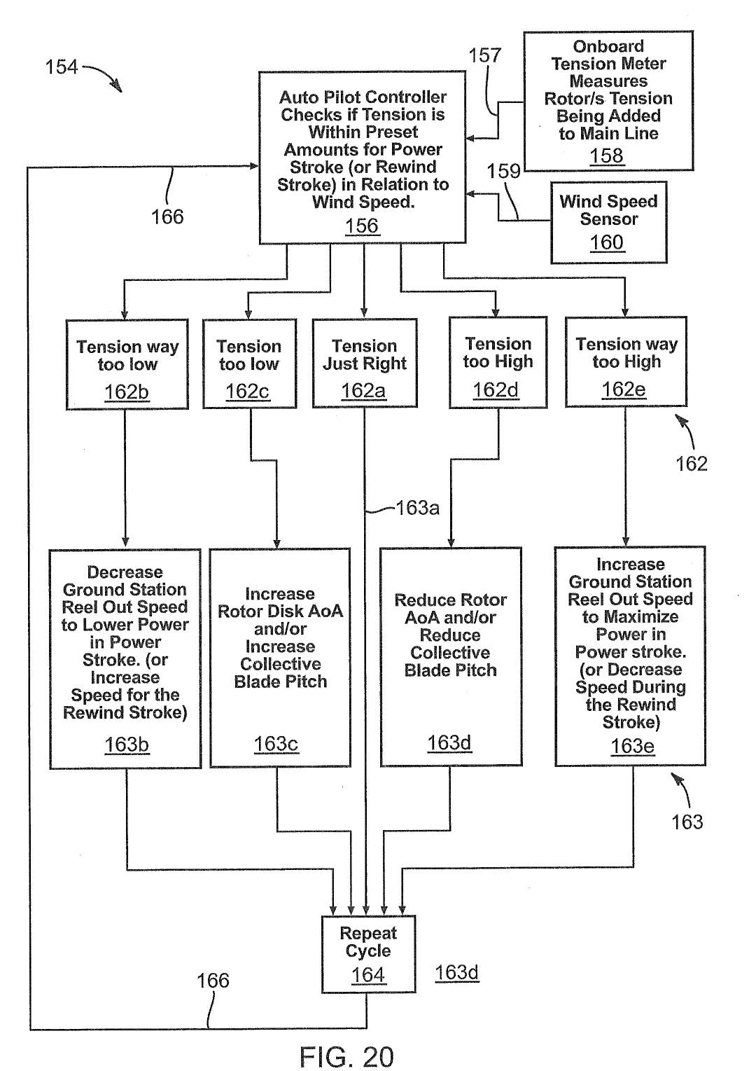

Referring to FIG. 20, in one embodiment of an apparatus and method in accordance with the invention, a system 154 may provide a method for controlling tension. Winds aloft are substantially more steady than winds near the nap of the earth. Accordingly, a controller 166 may determine whether tension is within preset amounts permitted for a power stroke. Likewise, the controller 156 may control 156 the tension by checking whether or not the tension is proper for a rewind stroke. The controller 156 may receive an input 157 from an onboard tension meter 158. The tension meter 158 may measure 158 the tension being added or the tension existing in the tether 14. Meanwhile, an input 159 from a wind speed sensor 160 may be provided to the controller 156 to indicate the wind 20 to which a particular aircraft 12 is exposed.

For example, a wind speed sensor 160 may provide an input 159 to the controller 156 indicating wind speed. Accordingly, the controller 156 may determine by an appropriate algorithm, whether or not the tension reported in the inputs 156 from the tension meter 158 is consistent with the configuration of the aircraft 12, the rotor 22, the blades 32, in particular, and the wind speed sensor 160 as an output 159 to the controller 156.

The controller 156 may report out the state 162 of the tether 14. For example, if the state 162a suggests tension is within the proper range, then the controller 156 may simply repeat 164 the monitoring cycle. If instead the tension state 162b reflects too low tension, then the controller 156 may act to decrease 163b the reeling speed at which the power is being generated. Thus, the controller 156 may fly the aircraft 12 in such way as to decrease 163b the ground station reel-out speed of the tether, in order to reduce the power in the power stroke. Likewise, if the tether 14 and the aircraft 12 are flying in on a rewind stroke, then the state 162b may cause the controller 156 to increase 163b the reel-in speed of the take up until 16 retrieving the tether 14.

If the state 162c exists, and tension is too low, outside the permissible operating range and at too low of a value, the controller 156 may increase 163c the rotor disk angle of attack 30 or alternatively, increase 163c the collective blade pitch 40. Thus, the blade angle of attack 40 or blade collective pitch 40 may be increased in order to increase lift forces 46, and increase thereby the tension in the tether 14.

If the state 162d results in tension too high for the structures on the ground, in the aircraft, or the tether 14 itself, the controller 156 may reduce 163d the rotor angle or attack 30, or reduce 163d the collective blade pitch 40 or blade angle of attack 40.

Finally, if the state 162e exists and the tension in the tether 14 is severely exceeding the permissible range of tension permitted in the tether 14, the controller 156, may fly the aircraft 12 to increase 163e the reel-out speed of the take-up unit 16, or decrease 163e the rewind speed of the take-up unit 16 during the rewind stroke. Thus, the speed of reeling, the collective pitch 40 or both may be controlled to reduce or otherwise control the tension. Ultimately, any of the states 162 detected, and the remedial actions 163 will eventually be fed back into a repeat 164 of the cycle sending in a new sensor output 166 or controller input setting 166 to the controller 156.

The commands 163 or remedies 163 may be set to operate in ranges. As an alternative embodiment, all of the commands 163 or remedies 163 may be implemented in continuous algorithms that operate various control parameters of the aircraft 12 in order to operate within a specified range of tension in the tether 14.

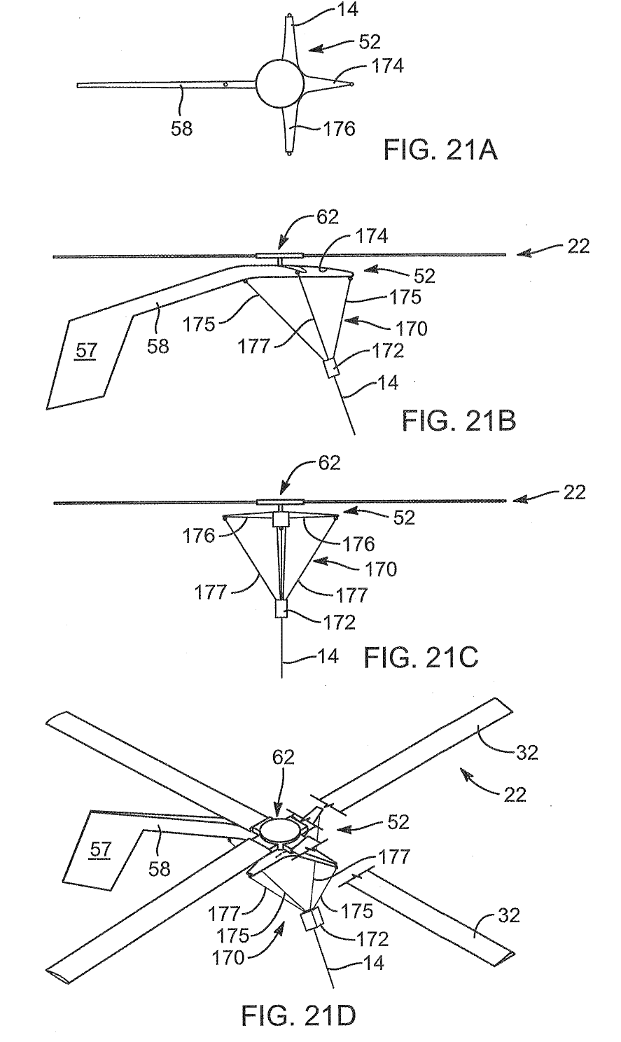

Referring to FIGS. 21A-21D, an alternative embodiment of an aircraft 12 may include a bridle 170, replacing certain portions of a rigid frame 52. For example, the frame portion may simply include the frame 52 illustrated in FIG. 21. Meanwhile, the bridle 170 may replace the tracks 66, 76 in the frames 62 described hereinabove.

For example, a controller 172 may draw an arm 174 down, or release it to travel up. One can see that the arm 174 is a pitch arm 174 and elevation of the arm 174 provides an increase in pitch, of the aircraft, while a decrease in the elevation of the pitch arm 174 decreases the pitch of the aircraft 12. Thus, the rotor angle of attack 30 may be modified by permitting the pitch arm to elevate 174 or to decline.

Lines 175 connected to the pitch arm 174, and to the aft portion of the frame 52 may be run through the controller 172 to extend or contract either of the portions of the lines 175. Thus, one may think of the lines 175 as a single line 175 passing through the controller 172, and distributed between the pitch arm 174 on the forward end of the aircraft 12, and the aft portion of the frame 52, near the boom 58 in the aft portion of aircraft 12.

Likewise, the right-to-left attitude of the roll arms 176 may be controlled by drawing the roll line 177 or operating on multiple roll lines 177 by the controller 172 in order to extend or shorten the distance from the controller 172 to a roll arm 176 on either side of the frame 52. Thus, in general, the bridle 170 may provide roll and pitch control of the frame 52, and thus the roll and pitch angles of the rotor 22 associated therewith.

The Bernoulli effect operates in liquids. However, it is not typically relied on to create lift. The reason is that liquid if passing by in a free stream, in order to constrict to a reduced area, must be drawn away from other liquid. Meanwhile, the Bernoulli effect in liquids is often seen with constriction of flow paths where the adjacent material is a solid wall in conduit conducting liquid, rather than a particular flow of liquid in a free stream, where all movement of liquid must be associated with displacement of adjacent liquid.

In certain alternative embodiments, an apparatus and method in accordance with the invention may work in water. The Bernoulli lifting effect is typically relied on for flight in gases. Nevertheless, other fluids, such as liquids, may also be used otherwise to advantage. For example, certain flows due to tides, rivers, and the gulf stream within the ocean propagate motion of large volumes and masses of fluid. In such an embodiment, the apparatus 10 may, but need not, operate as a windmill. Such a device may be anchored to rotate about a horizontal axis parallel to the fluid flow, thus operating as a “water mill.”

In certain waterborne embodiments, as well as airborne embodiments, a barge may anchor at a point in a body or stream of water. The generator system with its take-up unit may be installed on such a barge or on land at the surface of the body of water.

In one alternative embodiment, a rotor or sail may be tethered from a pulley secured to the floor of a body of water. Drag factors may be designed to differ between blades moving with and against the fluid flow. Thus, the flow of a current may tend to rotate the blades causing the blades to auger upward through the water drawing the line of the tether upward.

Similarly, storage of energy may be conducted in any suitable matter. In one embodiment, electrical energy generation is a suitable transformation of the energy of a rotor into a suitably distributable and storable medium. Alternatively, hydraulic power, compression of gas such as air or another working fluid, pumping water, or the like may be the result of the energy generated by the rotor in drawing the tether.

In certain embodiments, energy may be generated in a mechanical form rather than electrical form and used directly. For example, compressed gases, a flow of water, or the like may be used to propel various transportation modes.

Similarly, in certain embodiments the tether 14 may be connected directly to tow or to generate power on water craft, such as boats or ocean going ships. Rather than a sail providing power, a rotor may provide electrical power or mechanical power to drive the screws of a ship. Even with lower power generation capacities, an apparatus 10 in accordance with the invention may provide power to operate electrical, control and like types of equipment on board a ship, even while the ship continues to move across the ocean.

In certain embodiments, an apparatus 10 in accordance with the invention may serve as a tower aloft carrying communication devices, telephone cell repeaters, radar systems, weather sensors, atmospheric sensors, fire detection devices, ground sensors, and the like. The altitude, stability, and available power from an apparatus 10 in accordance with the invention may provide an excellent platform with supporting power to such devices.

In certain embodiments, the blade angle of attach 40 may be controlled by a “smart metal” having a memory. Accordingly, upon temperature change, the metal may deflect, causing a change in pitch of the blade to which the smart metal serves as a mounting. Meanwhile, other actuators, including those enclosed in the Groen patent reference incorporated herein by reference above, and other apparatus known in the art, may be used to control on demand the blade angle of attack 40 of the rotor.

The hardware and method may include providing a tether having first and second ends, the first end positioned proximate the earth and the second end extending aloft. After providing a take-up devise selectively and cyclically reeling in and reeling out the tether proximate the first end thereof, one may provide a rotorcraft secured to the tether proximate the second end thereof, the autogyro comprising a rotor rotating about an axis of rotation and comprising blades acting as wings rotatably secured to a frame, the rotor having a rotor pitch defined by the path of the rotor with respect to the incoming wind and blade pitch, defined respectively for each blade of the blades by the angle of the each blade with respect to the incoming wind.

By tensioning the tether, against a resistance provided by the take-up device, controlling a first value of the tensioning by flying the autogyro aloft while reeling out the tether, and controlling a second value of the tensioning by flying the autogyro downward while reeling in the tether, one may transfer power to the take-up device by the tether. Transferring power from the take-up device to a machine remote from the take-up devise may thus operate the machine.

The foregoing may include further providing an electrical generator, connecting it to the take-up device, delivering the power mechanically to the generator from the take-up device; and converting the power, by the generator, to electrical power, after securing the take-up device proximate a surface of the earth, whether land and water.

A first value of tensioning, greater than the second value may be effected by a controller controlling tension in the tether by flying the autogyro between a first lower position comparatively nearer the take-up device and a second lower position comparatively farther from the take-up device. Providing and connecting at least one second rotorcraft to the tether is an option, but may complexify control and clearances.

Controlling the tension may be effected by selectively increasing the tension for a power stroke during the flying aloft and decreasing the tension during a recovery stroke during the flying downward by controlling, a blade angle of attack representing the angle of the blades with respect to incoming wind. Controlling the blade angle of attack may be effected by controlling the rotor pitch, the rotor pitch being a rotor angle of attack representing the angle between the incoming wind and a plane defined by a rotating sweep of a radially outermost point on the rotor.

In one embodiment, controlling may include providing a mast colinear with an axis of rotation of the rotor and effecting controlling the rotor pitch by controlling a tilting angle of the mast with respect to the frame. A bridle comprising first and second lines, each flexible in bending and substantially inextensible in length, may be effected by connecting first and second ends of the first line proximate a fore end of the frame and an aft end of the frame, respectively, fore and aft defining a fore-to-aft axis substantially parallel to the direction of the incoming wind.

Thereafter one may connect first and second ends of the second line to a left side and a right side of the frame to define a left-to-right axis orthogonal to a fore-to-aft axis. Finally, connecting a first intermediate point, between the first and second ends of the first line to a pitch control secured to the frame and connecting a second intermediate point, between the first and second ends of the second line to a roll control secured to the frame may provide the needed structures.

Thereupon, one may control the tilting angle of the mast by controlling a distribution of the first line between a first portion, extending between the first end thereof and the pitch control, and a second portion, extending between the second end thereof and the pitch control. Controlling a roll angle of the rotor with respect to the frame may be done by controlling a distribution of the second line between a first portion, extending between the first end thereof and the roll control, and a second portion, extending between the second end thereof and the roll control.

The flying aloft and flying down may be controlled by a computer, programmed and operably connected to control the roll control and pitch control. A mast may be canted toward the left or right side of the frame to control the rotor roll angle with respect to the frame being non-zero. Passive control of the blade pitch may be done by controlling rotor pitch, or by a blade pitch controller acting independently from rotor pitch, or the like, such as controlling the blade pitch by both actively and passively affecting the angle of attack of the blade.

Controlling the tension in the tether may include changing lift of the rotor by one or more of providing a coupled change in the blade angle of attack by changing the rotor pitch, by, in turn, tilting the axis of rotation of the rotor. A teetering hub connecting the blades together may have a blade-angle-of-attack controller extending from the rotor to the blades; and may have a swash plate as an active control for the blade pitch. Reducing the tension by reducing the blade angle of attack and increasing the tension by increasing the blade angle of attack may effect a power stroke. Reducing and increasing the blade angle of attack may occur by reducing and increasing, respectively, the rotor pitch.

An autopilot may control the tension by controlling blade pitch. The control system may continuously monitor the tension, providing control signals to the autopilot based on the tension, and the autopilot may automatically select and control the relative velocity of the autogyro with respect to the incoming wind, selectively reel out and reel in the tether, or both.

Providing a generator onboard the rotor may be done by having a first winding fixed with respect to an outer race moving with the blades and a second winding fixed with respect to an inner race substantially fixed in a rotational direction with respect to the frame. The autopilot controlling flying of the autogyro may be powered by that generator, may have power storage, and may include actuators effective to control blade pitch.

Pre-rotating the rotor in the incoming wind by setting the blade angle of attack at a negative value may help in transferring momentum between the incoming wind and the blades, the rotor operating as a windmill, a wind turbine, or both. A biasing element effecting a reduction of blade pitch may rely on urging pivoting of the blades towards the axis of rotation. Urging of the biasing element by the centrifugal force urging a leveling of the blades in the rotor in response to an increase in the speed of rotation of the rotor about the axis of rotation may self stabilize this control process. An active control selectively pivoting the blades between a turbine position having a negative blade pitch and an autogyro position having a positive blade pitch is one such option, whether a mechanical, electrical, or combination actuator.

In some embodiments, a gimbal may be secured to the rotor to support rotation of the rotor therearound. A pivot may support rotor pitch by pivoting the gimbal to pitch with respect to the frame. The ratio of lift to drag of the rotor disk should be equal to the ratio of the length to the height of the offset of the center of rotation of the rotor imposed by the distance from the axis of rotation to the pivot, and the height of the center of rotation above the pivot, respectively. An actuator moves the gimbal with respect to the frame, whether a mechanical actuator, electrical actuator, an hydraulic actuator, or a combination.

Suspending the frame and tether from the rotor is done by establishing a center of load, the load being exerted by the tether, at a point below a center of lift comprising a center of pressure of the rotor. A ground station, proximate the take-up device, a wireless communication link between the ground station and the autogyro, and an automatic fail-safe-device are effective to urge the autogyro to reduce tension in the tether in response to a failure of at least one of communication, control power, and flight controls.

The frame may include a track defining a path of an actuator effecting rotor pitch, and may have a detent effective to bias the actuator to dwell thereat along the track, between a first arc forward of the detent, and a second arc rearward of the detent. The detent position may be selected to position the rotor in a position urging the autogyro to reduce tension in the tether. For example, fail safe flight may be obtained through tilting the frame to position the actuator at the detent in response to a failure of at least one of communication to the autogyro, power to controls controlling flight of the autogyro, and actuators effecting control of the flight of the autogyro.

The detent may simply be a vertex connecting the first and second arcs, but effective to position the actuator at the lowest point between the track and the tether, relative to the first end of the tether. The vertex may correspond to a low power setting for the autogyro and correspond to a be near or at substantially the lowest tension in the tether for the designed range of operational speed of the incoming wind.

In some embodiments, a trim tab may be operably connected to the frame, thus providing for adjusting tension in the tether by adjusting the position of the trim tab with respect to the frame in response to the speed of the incoming wind. Additional control may provide reeling in the autogyro, by the take-up device, in response to a reduction in the speed of the incoming wind below a threshold value. Alternatively, the controls may effect reeling in the rotorcraft at a relative velocity selected to fly the autogyro substantially to the take-up device under controlled flight.

For short-term, temporary assistance, jets may be secured to the blades, effective to rotate the rotor in powered flight. For emergency control needs of incoming rotorcraft, or in response to the speed of the incoming wind dropping beyond a threshold value required for at least one of controlled flight and power generation. Another alternative mechanism for managing the tension in the tether is by the rotor responding thereto, the rotor blades moving to a position of decreased blade pitch in response to an increase in the tension and an increase in blade pitch in response to a decrease in the tension.

Effecting change in the blade pitch may be done by coupling blade pitch to a coning angle of the blades in the rotor, the coning angle representing an angle between an axis of a blade and the axis of rotation of the rotor. Effecting a change in coning angle may be made by changing the balance of forces acting on the blades between the tether and the incoming wind.

Landing may involve locating a landing surface proximate the take-up device, the landing surface defining a surface in space. One mayextend the tether from the take-up device through the surface in space, the take-up device drawing the tether through the surface in space; and landing the autogyro on the landing surface. The system may include legs secured to the frame. Thus, contacting the landing surface by at least one of the legs; and positioning the rotor to rotate in a plane parallel to the landing surface by tilting the frame, the rotorcraft may be oriented by the leg, in response to the contact.

Instrumentation on the frame may be held aloft at a substantially fixed altitude, the rotorcraft operating as a high-altitude tower. Alternatively, a navigation system secured to the frame may cooperate with an autopilot secured to the frame. The autopilot may control in response to the position thereof detected by the navigation system. The navigation system may be a global positioning system, an omni beacon detector, or the like.

One may provide a second tether, take-up device, and rotorcraft to generate power, with or without a second navigation system operably connected to a second autopilot controlling the second autogyro. Thus one may cooperatively operate the first and second navigation systems to control the first and second autopilots, respectively to avoid interference between the two rotorcraft. Thus proximities may be closer for installations of power generation units. A rangefinder may, instead or in addition, detect proximity of the rotorcraft to the ground, the autopilot controlling the flight attitude of the autogyro in response to communications received by the autopilot from the rangefinder. Typically, the autopilot may be programmed to reduce rotor pitch in response to increasing proximity of the rotor to the ground during landing.

In one embodiment, a generator, take-up device, and their support may be installed on a structure, with a platform pivotable with respect to the structure. Positioning the autogyro on the platform may provide a relative wind angle favorable for pre-rotating the rotor. The structures may be a landing strip, a building, a barge, a buoy, a watercraft, or the like. The platform may swivel from zero to 360 degrees or more about a vertical axis. Thus whether landing or launching, one may pivot the platform to present a top surface thereof for landing or launching the autogyro.

Operating jets may be secured to the blades to pre-rotate the rotor before launch, even during reeling out the tether to an altitude chosen to expose the rotor to wind sufficient to support autorotation of the rotor. The jets may shut down upon detection of autorotation at a threshold level preselected for operation of the autogyro.

Multiple rotorcraft may be connected to a single tether, and single take-up device, all operably connected to deliver power. Thus one may fly the plurality of rotorcraft aloft, fly them down to a landing surface, retrieve each individually, one at a time, or both; and even remove each from the tether. Typically, a rotor bearing for each rotor, corresponds to each rotorcraft, with an inner race and an outer race. One may thread all the inner raced onto the tether, then selectively connect and disconnect the frame of each rotorcraft the inner race of the bearing corresponding thereto. One may, at the same time or separately, selectively secure to the respective outer race and remove therefrom, the blades corresponding to each rotor. Thus the blades may be stored separately from the bearings.

One may provide motive structure, such as a motor of any suitable type, secured to the blades. Upon detecting an emergency situation, one may operate the motive structure to maintain controlled flight of the autogyro. Jets, propellers, fueled engines, electric motors, or the like may serve this function.

With a bearing supporting rotation of the blades about the axis of rotation, an attachment may be made between each of the blades and the bearing. Thus an attachment to an actuator may provide for controlling blade pitch by selectively pivoting each or all of the blades by action of the actuator corresponding thereto. The actuator may be or include “smart metal” having a “memory” tending to change the pitch of the blade connected thereto in response to selectively heating and cooling the smart metal to pivot the blade between a first position corresponding to a first pitch and a second position corresponding to a second pitch.

The present invention may be embodied in other specific forms without departing from its spirit or essential characteristics. The described embodiments are to be considered in all respects only a illustrative, and not restrictive. The scope of the invention is, therefore, indicated by the appended claims, rather than by the foregoing description. All changes which come within the meaning an range of equivalency or the claims are to be embraced within their scope.

What is claimed and desired to be secured by the United States Letters Patent is:

1. A method comprising:
providing a tether having first and second ends, the first end positioned proximate the earth and the second end extending aloft;
providing a take-up devise selectively and cyclically reeling in and reeling out the tether proximate the first end thereof;
providing a rotorcraft secured to the tether proximate the second end thereof, the rotorcraft comprising a rotor rotating about an axis of rotation and comprising blades acting as wings rotatably secured to a frame, the rotor having a rotor pitch defined by the path of the rotor with respect to the incoming wind and blade pitch, defined respectively for each blade of the blades by the angle of the each blade with respect to the incoming wind;
tensioning, by the rotorcraft, the tether, against a resistance provided by the take-up device by modulating lift using controlled changes in at least one of rotor pitch and blade pitch;
controlling a first value of the tensioning by flying the rotorcraft aloft in an outbound direction, while reeling out the tether;
controlling a second value of the tensioning by flying the rotorcraft downward in an inbound direction, while reeling in the tether;
transferring power to the take-up device by the tether;
transferring power from the take-up device to a machine remote from the take-up devise to operate the machine.

2. The method of claim 1, wherein the rotorcraft further comprises a controller controlling tension in the tether by flying the rotorcraft between a first lower position comparatively nearer the take-up device and a second upper position comparatively farther from the take-up device.

3. The method of claim 2, wherein controlling the tension further comprises:
selectively increasing the tension for a power stroke during the flying aloft and decreasing the tension during a recovery stroke during the flying downward by controlling, a blade angle of attack representing the angle of the blades with respect to incoming wind.

4. The method of claim 3, further comprising:
controlling the blade angle of attack by controlling the rotor pitch, the rotor pitch being a rotor angle of attack representing the angle between the incoming wind and a plane defined by a rotating sweep of a radially outermost point on the rotor.

5. The method of claim 4, further comprising:
providing a mast colinear with an axis of rotation of the rotor;
effecting controlling the rotor pitch by controlling a tilting angle of the mast with respect to the frame.

6. The method of claim 1, further comprising:
flying the rotorcraft with the mast canted toward at least on of the left and right sides of the frame, the rotor roll angle with respect to the frame being non-zero.

7. The method of claim 1, further comprising controlling the blade pitch by both actively and passively affecting the angle of attack of the blade.

8. The method of claim 1, wherein controlling the tension in the tether further comprises changing lift of the rotor by at least one of:
providing a coupled change in the blade angle of attack by changing the rotor pitch, by, in turn, tilting the axis of rotation of the rotor;
providing a teetering hub connecting the blades together, the teetering hub having blade-angle-of-attack controllers extending from the rotor to the blades; and
providing a swash plate as an active control for the blade pitch.

9. The method of claim 8, further comprising reducing the tension by reducing the blade angle of attack and increasing the tension by increasing the blade angle of attack.

10. The method of claim 9, further comprising reducing and increasing the blade angle of attack by reducing and increasing, respectively, the rotor pitch.

11. The method of claim 1, further comprising providing an autopilot controlling the tension by controlling blade pitch.

12. The method of claim 11, further comprising:
continuously monitoring the tension;
providing control signals to the autopilot based on the tension; and
controlling the tension by the autopilot automatically selecting and controlling the relative velocity of the rotorcraft with respect to the incoming wind.

13. The method of claim 12, further comprising controlling the tension by controlling the take-up device to selectively reel out and reel in the tether.

14. The method of claim 1, further comprising:
providing a trim tab operably connected to the frame; and
adjusting tension in the tether by adjusting the position of the trim tab with respect to the frame in response to the speed of the incoming wind.

15. The method of claim 1, further comprising:
reeling in the rotorcraft, by the take-up device, in response to a reduction in the speed of the incoming wind below a threshold value.

16. The method of claim 15, further comprising reeling in the rotorcraft at a relative velocity selected to fly the rotorcraft substantially to the take-up device under controlled flight.

17. The method of claim 1, further comprising managing the tension in the tether by the rotor responding thereto, the rotor blades moving to a position of decreased blade pitch in response to an increase in the tension and an increase in blade pitch in response to a decrease in the tension.

18. The method of claim 17, further comprising effecting change in the blade pitch by coupling blade pitch to a coning angle of the blades in the rotor, the coning angle representing an angle between an axis of a blade and the axis of rotation of the rotor.

19. The method of claim 18, further comprising effecting a change in coning angle by changing the balance of forces acting on the blades between the tether and the incoming wind.
